(19) United States
(12) Patent Application Publication
(10) Pub. No.: US 2026/0299192 A1
(43) Pub. Date: Oct. 1, 2026

(54) LITHOGRAPHY-FREE PROGRAMMABLE INTEGRATED PHOTONICS

(71) Applicant: THE TRUSTEES OF THE UNIVERSITY OF PENNSYLVANIA, Philadelphia, PA (US)

(72) Inventors: Liang FENG, Wynnewood, PA (US); Tianwei WU, Philadelphia, PA (US); Marco MENARINI, Philadelphia, PA (US); Zihe GAO, Philadelphia, PA (US)

(21) Appl. No.: 19/477,824

(22) PCT Filed: Apr. 25, 2024
(86) PCT No.: PCT/US2024/026201

§ 371 Date: Oct. 23, 2025

Related U.S. Application Data
(60) Provisional application No. 63/498,477, filed on Apr. 26, 2023.

(51) Int. Cl. G02B 6/12; G06N 3/067

(52) U.S. Cl. CPC G02B 6/12; G06N 3/0675; G02B 2006/12078; G02B 2006/12128; G02B 2006/12142

(57) ABSTRACT

Provided are systems and methods for lithography-free programmable integrated photonics. Various embodiments include a medium having a lithography-free region, and a photonics processor. Under illumination, the medium can exhibit a pumping pattern defining a gain-loss distribution on the lithography-free region, and the photonics processor can modulate the pumping pattern of the lithography-free region by spatially modulating the pumping pattern based on an imaginary-index distribution.

### CROSS REFERENCE TO RELATED APPLICATIONS

The present application claims priority to and the benefit of U.S. patent application No. 63/498,477, “Lithography-Free Programmable Integrated Photonics” (filed Apr. 26, 2023). All foregoing applications are incorporated herein by reference in their entireties for any and all purposes.

### GOVERNMENT RIGHTS

This invention was made with government support under 2023780 awarded by the National Science Foundation and W911NF-21-1-0148 awarded by the Army Research Laboratory and W911NF-21-1-0340 awarded by the Department of Defense, Defense Advanced Research Projects Agency. The government has certain rights in the invention.

### TECHNICAL FIELD

The present disclosure relates to integrated photonic devices, and to integrated photonic signal processing.

### BACKGROUND

Photonics form the backbone of information infrastructure, enabling processing of large datasets at an unprecedented speed with minimal energy consumption by the exploitation of intrinsic parallelism, elevated frequency rates, and large bandwidths that inherently come with working in the optical domain¹⁻⁶. Integrated photonics are critical to ease ongoing data traffic, for its intrinsic high speed, large bandwidth, and unlimited parallelism. Its technological enabler is high-precision lithography, allowing for fabrication of high-resolution photonic structures.

Targeting in-situ signal control, information processing, or general photonic computational operations, programmability and multifunctionality become critical as photonic integrated circuits are evolving into a new era⁷⁻¹³. Reconfigurable switching and routing photonic fabrics become emerging provided heterogeneous integration of a variety of materials¹⁴⁻¹⁶ (such as phase change materials) or structures^{17,18} (such as microelectromechanical systems (MEMS)) with tunable optical properties on semiconductor photonic chips.

However, in the existing integrated photonic platform, controls of optical signals are implemented by cascading discrete devices, where each device is of single functionality and distinct morphology, predefined by high-precision lithography for multi-layered structures, specific for its task. Strategic node connections of single devices (such as coupled waveguides, splitters, filters, phase shifters, etc.) must be conducted to realize on-chip networks¹⁹⁻²¹. When scaling up, the complexity of the architecture inevitably grows exponentially as the number of connecting nodes and the number of single devices both increase nonlinearly with the size of the chip²². As a consequence, extremely complex architectures become inevitable to realize fully reconfigurable, high-performance integrated photonic processors to handle data-intensive tasks, such as in-situ training of modern artificial intelligence.

Additionally, it remains a challenge to precisely control nano-lithographic features during fabrication and manufacturing of very large-scale integrated photonics^{23,24} as any lithographic imperfection can cause a defect that degrades or even completely deteriorates the designed performance.

### SUMMARY

The present disclosure describes systems and methods to provide photonics processing. Various aspects and examples can include receiving at least one optical signal at a medium, wherein the medium comprises a lithography-free region, and wherein the medium optionally comprises a microchip, generating a first pumping pattern on the lithography-free region, the first pumping pattern defining a gain-loss distribution, spatially modulating the first pumping pattern based on an imaginary-index distribution to generate a second pumping pattern, and collecting an output from the medium.

According to some examples, systems and methods can further monitor the medium to detect the first pumping pattern and determine the imaginary-index distribution based on the first pumping pattern and a target matrix. In some examples, systems and methods can generate the imaginary-index distribution from a machine learning model trained to a target matrix. The target matrix can be an optimized power transmission matrix.

In various embodiments, a spatial light modulator (SLM) can be applied to spatially modulate the first pumping pattern. Spatial modulation can occur in real-time, and in some examples, the optical signal can be generated from converted optical signals, audio files, video files, and the like.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

Additional advantages will be set forth in part in the description which follows or can be learned by practice. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate embodiments and together with the description, serve to explain the principles of the methods and systems.

The patent or application file contains at least one drawing executed in color. Copies of this patent or patent application publication with color drawing(s) will be provided by the Office upon request and payment of the necessary fee.

In the drawings, which are not necessarily drawn to scale, like numerals can describe similar components in different views. Like numerals having different letter suffixes can represent different instances of similar components. The drawings illustrate generally, by way of example, but not by way of limitation, various aspects discussed in the present document. In the drawings:

FIGS. 1A-1B illustrate lithography-free integrated photonic processor for on-chip signal processing and network training. FIG. 1A provides a conceptual illustration of the imaginary-index-driven processor with real-time feedback, together with signal encoding and detection modules. With the signal encoded as the intensity of input light in different input channels (Iᵢ), the matrix operation based on the imaginary index,

$${T}_{j i} ( {ε}_{i m a g}^{m} ( r ) )$$

in training epoch m, is fully programmed by an external pumping pattern generated by an SLM. The pattern as a function of

$${ε}_{i m a g}^{m} ( r , {I}_{i} , {O}_{j}^{m} , {O}_{j}^{T} )$$

is real-time optimized to perform an in-situ training of a photonic neural network, based on the measured powers versus the targets in different output channels

$$( {O}_{j}^{m} vs . {O}_{j}^{T} ) .$$

FIG. 1B provides an information processing area of the lithography-free imaginary-index-driven processor is a layer of unpatterned InGaAsP. Its networking connectivity and computational function can be dynamically reconfigured by the spatial-temporal control of pumping patterns during the training process. Here, the bottom panels display a sequence of pumping patterns updated after each training epoch.

FIGS. 2A-2E illustrate the two algorithms used to generate the imaginary-index maps to execute the target matrix operation. The offline algorithm (top panel) is simulation-based. The flow chart shows the procedure in one optimization iteration targeting at a specific power transmission matrix between the input and output ports. Electromagnetic fields are simulated in the parallel FDFD solvers excited by each input channel (e₃ is shown here for excitation I₃). Next, the corresponding adjoint fields launched from the outputs are subsequently simulated

$$( {e}_{3}^{a d j} ) .$$

The gradient information

$$( \frac{- d {L}_{3}}{{ε}_{i m a g}} )$$

is extracted from the product of the simulated field distribution and its adjoint field. Finally, the change of the imaginary index Δε_{imag}(r) shown in the right panel is achieved based on the global gradient from all parallel solvers and a step constant δ. The online algorithm (bottom panel) is measurement-based. N measurements are performed rather than the computation-expensive large-scale electromagnetic simulations. The power in all the output channels is measured with the input channel excited one by one. An approximate gradient

$$( \frac{\approx - d {L}_{3}}{{ε}_{i m a g}} )$$

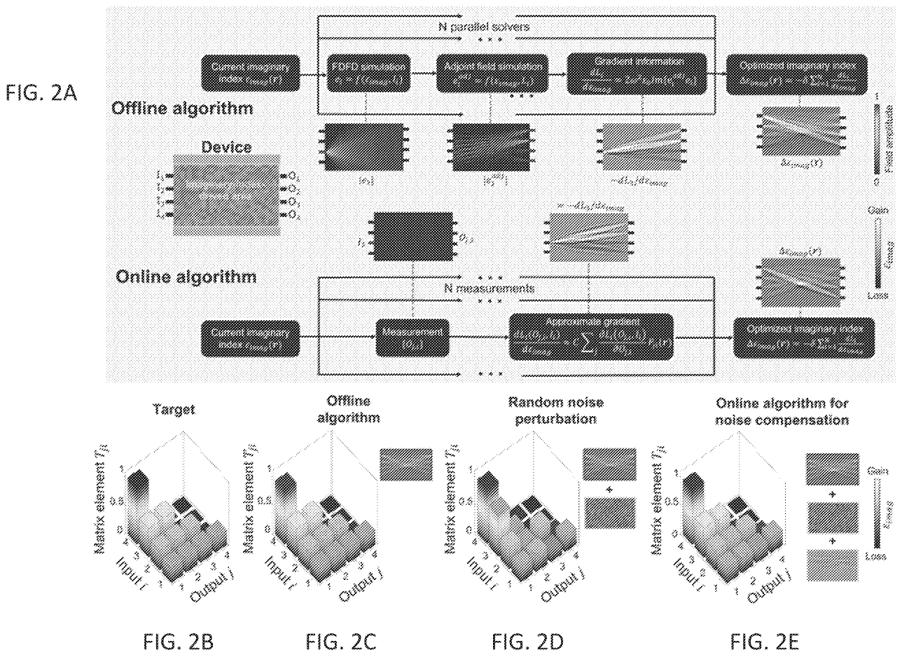

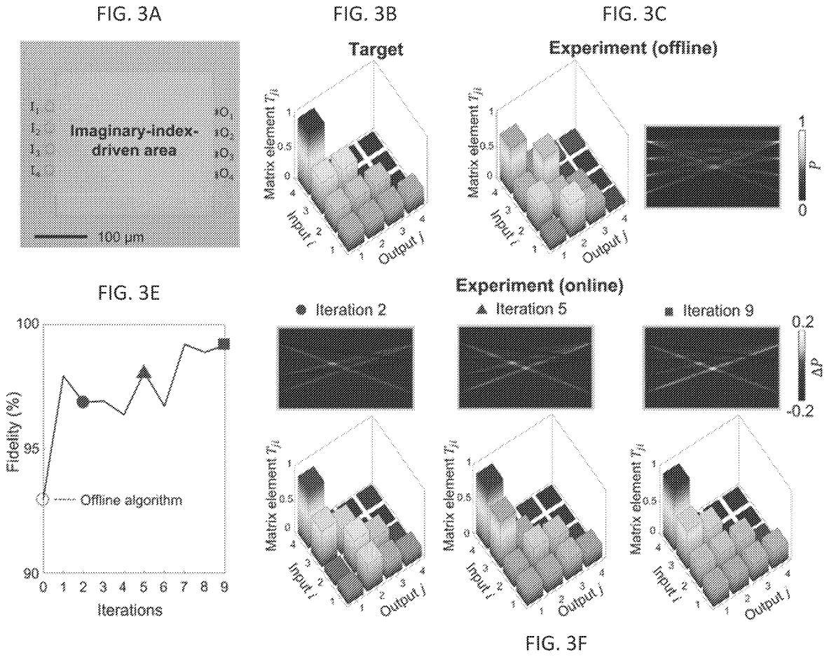

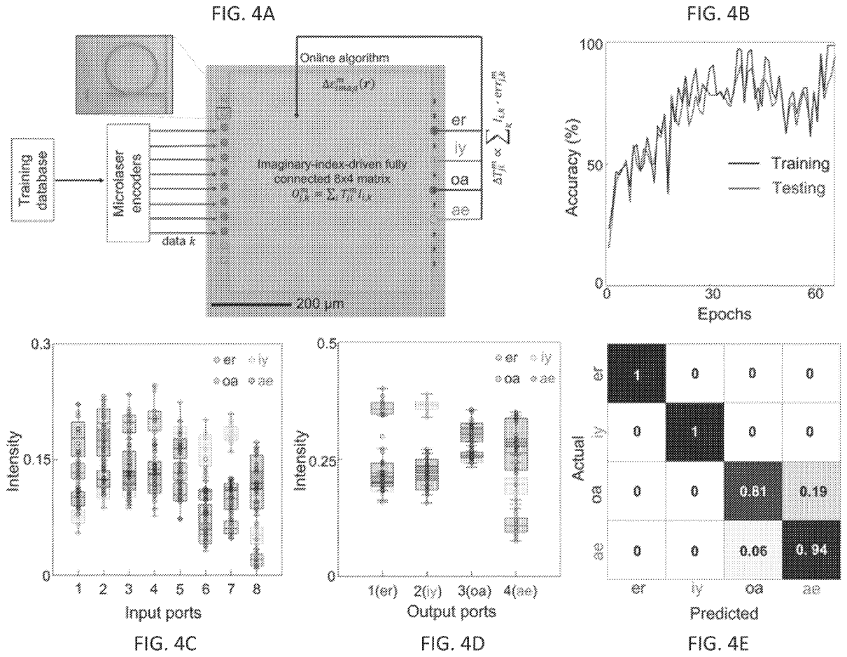

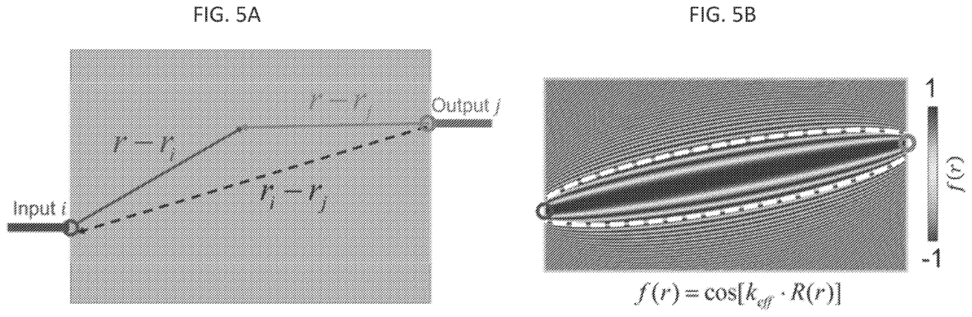

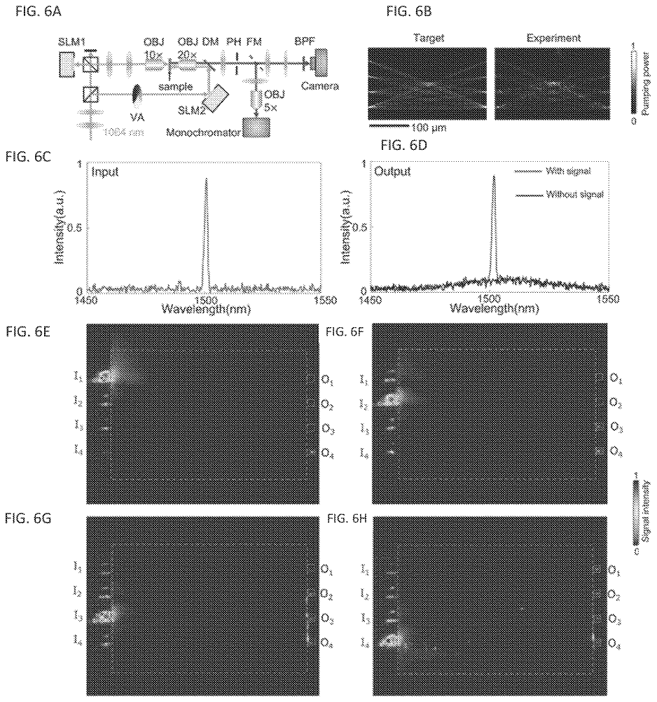

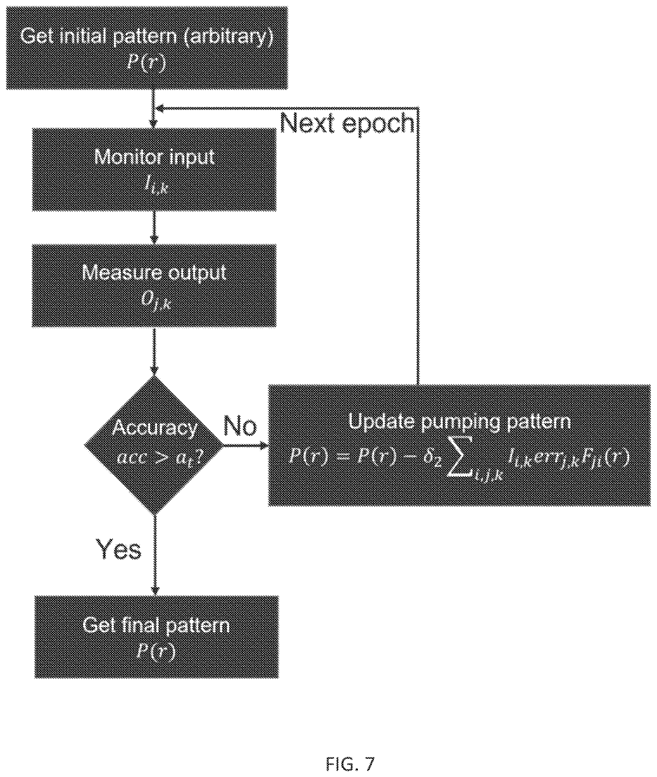

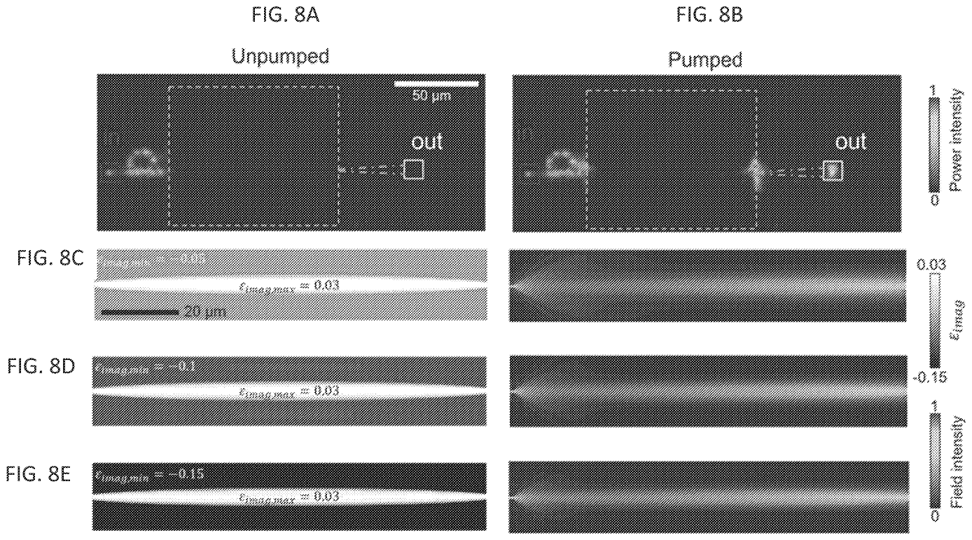

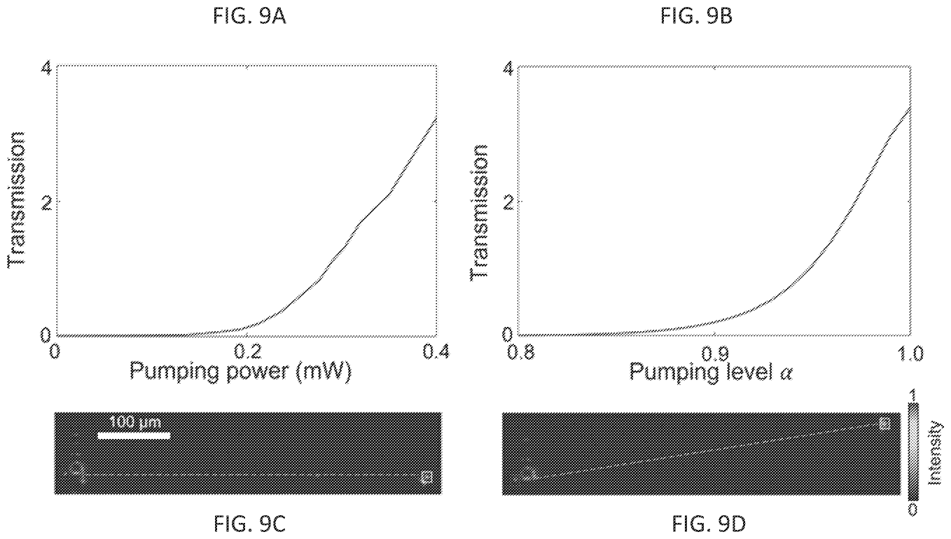

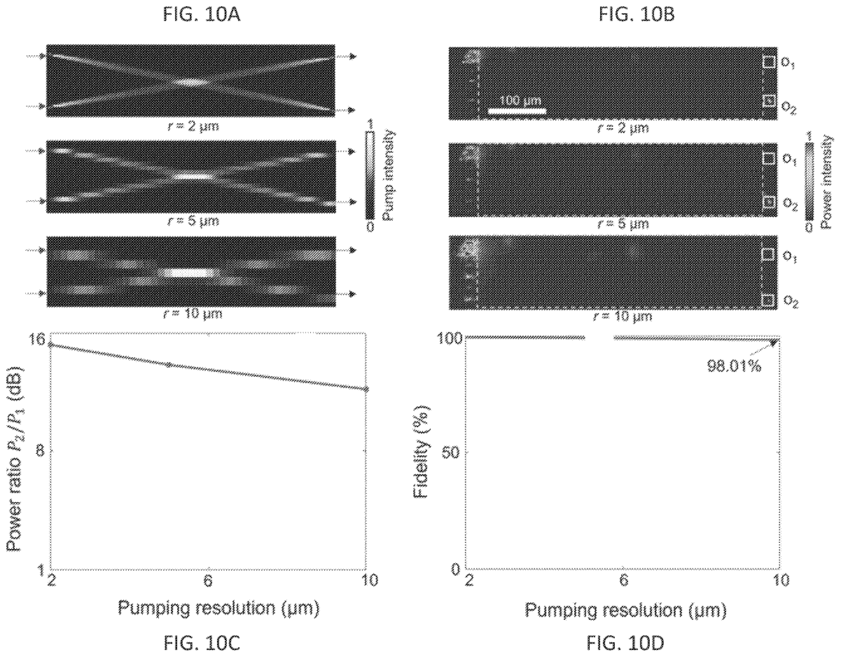

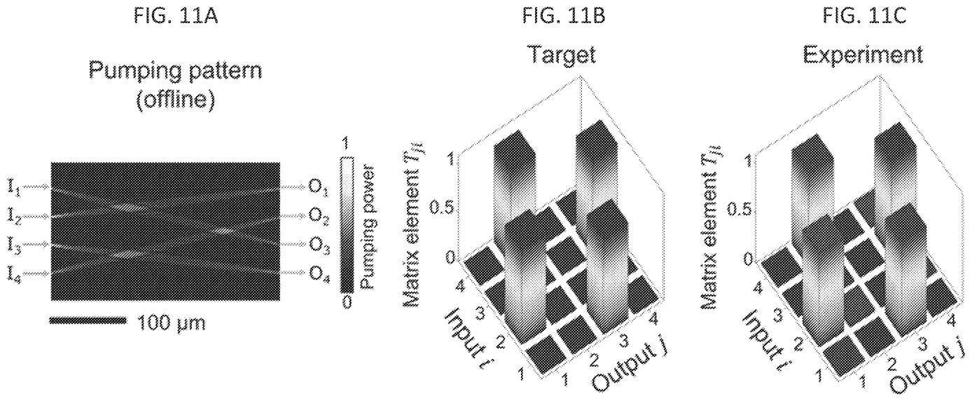

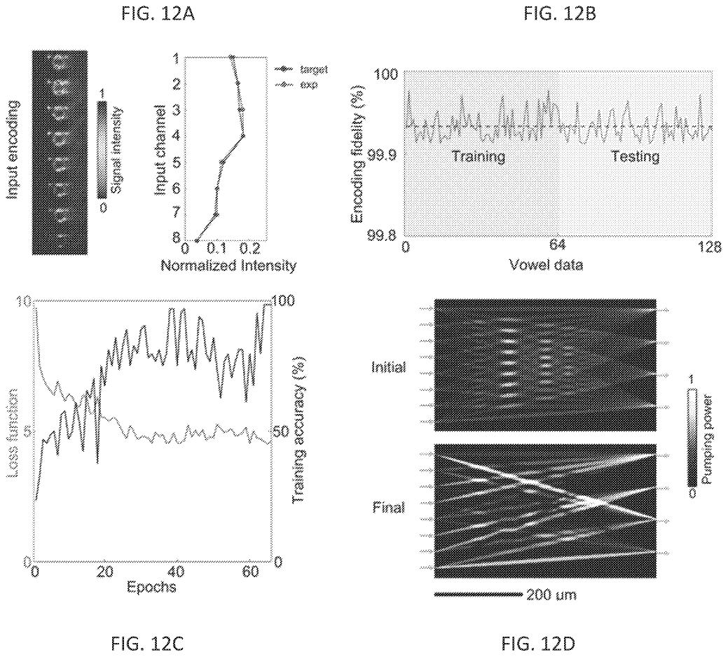

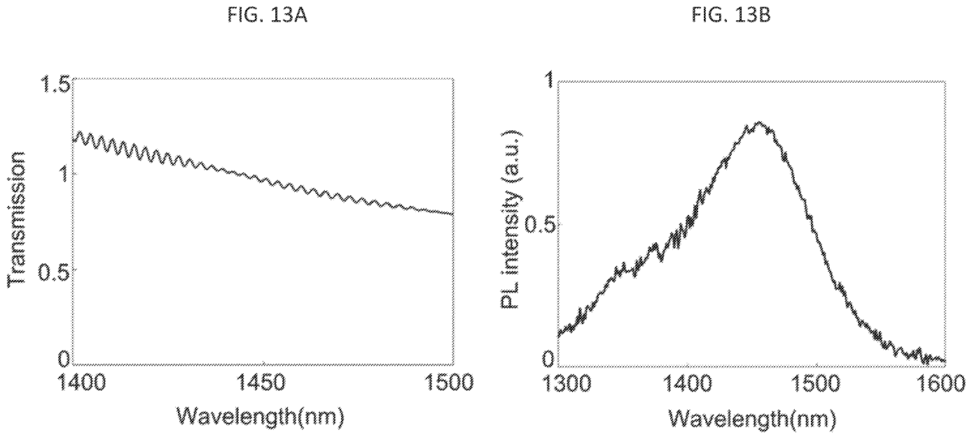

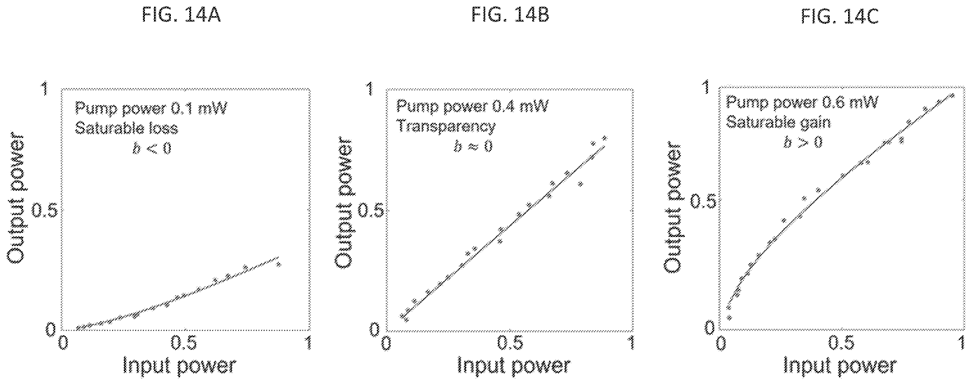

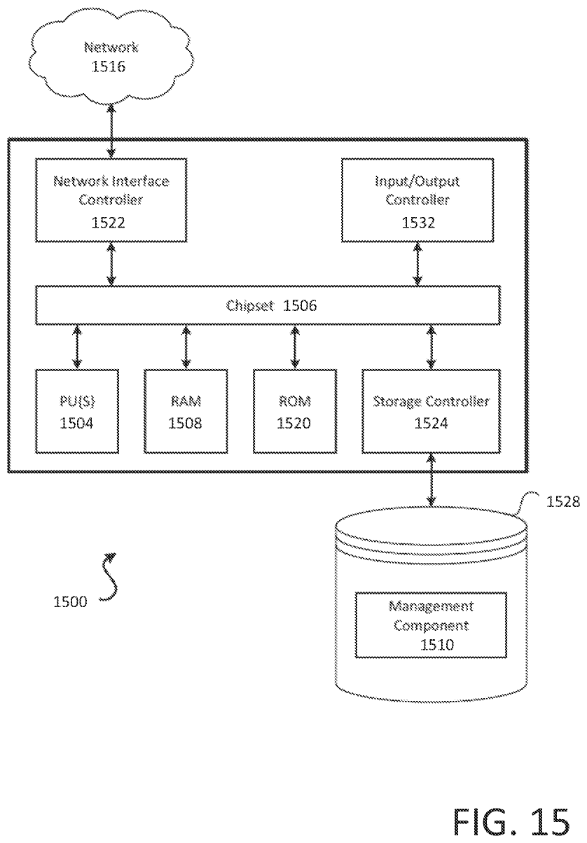

is extracted by using only the measurement results and predefined spatial maps {Fⱼᵢ(r)}, which highly resembles the precise gradient extracted by the offline algorithm. The change of the imaginary index Δε_{imag}(r) shown in the right panel is again achieved based on the global gradient. FIGS. 2B-2E provide simulation results as an example of a robust arbitrary power transmission matrix programmed by the imaginary-index-driven inverse design algorithms. FIG. 2B illustrates target transmission matrix elements. FIG. 2C illustrates a transmission matrix and the spatial imaginary index calculated by the offline algorithm only (inset box; top box in FIG. 2D). FIG. 2D illustrates a transmission matrix is perturbed by a random perturbation of the imaginary index (bottom box; middle box in FIG. 2E). FIG. 2E illustrates an online algorithm applied to compensate the random perturbation for the revival of the target matrix. The imaginary-index spatial map (bottom box in FIG. 2E) corresponds to the change of the imaginary index optimized by the online algorithm.

FIGS. 3A-3F illustrate Experimental demonstration of an imaginary-index-driven arbitrary matrix processor. FIG. 3A illustrates an optical microscope image of a 4×4 device on the InGaAsP platform, consisting of an unpatterned imaginary-index-driven area for signal processing, connected to four microring lasers for input signal encoding (I₁-I₄) and four grating couplers for output signal detection (O₁-O₄). FIG. 3B illustrates target transmission matrix. c, Measured transmission matrix (left) with the pumping pattern generated by the offline algorithm (right). FIG. 3D illustrates an online algorithm applied to improve the fidelity of the matrix operation. A fidelity of 99.2% is achieved after 9 iterations. FIG. 3E illustrates an evolution of the pumping profile change ΔP (top panels) lead to the real-time optimization of the matrix operation (bottom panels). Although the lithography-free processer can in principle respond as fast as the carrier lifetime of InGaAsP (i.e., ~200 ps³⁵), real measurements in one iteration (5 frames) take approximately 100 ms, limited by the frame rate of infrared camera.

FIGS. 4A-4E illustrates in-situ training for vowel recognition. FIG. 4A illustrates an optical microscope image of the device and the schematic for in-situ training of a 4-class vowel recognition task. Eight input channels (purple channels, data k) and 4 output channels (er, iy, oa, and ae corresponding to different vowel classes) are used. The features extracted from the raw audio files are applied as the input neurons, which are encoded by the microring lasers and monitored by the camera through the laser output from left (see the inset for details). The central yellow box marks the imaginary-index-driven photonic processor for this in-situ training task, where the pumping pattern is updated after each training epoch by the online algorithm. FIG. 4B illustrates an evolution of recognition accuracy of the training (black) and testing (red) data with iterative training epochs. FIGS. 4C and 4D are scattering plots of the measured power at input and output ports for all 64 testing data after training, respectively. The 4 vowel classes are marked in different colors corresponding to color selections in FIG. 4A. For each vowel class, its associated interquartile range (indicated by the boxes) is featured in all the input and output ports. Here, the colored line inside each box is the median and the back lines outside the box show the upper and lower bounds of each class. FIG. 4E provides a confusion matrix for the testing data, where the values are normalized in each row.

FIGS. 5A-5B illustrate an example of the online algorithm. FIG. 5A provides an illustration of the geometry related to input port i and output port j. FIG. 5B illustrates the spatial function ƒ(r). The isovalue contours are the ellipses with 2 focal points at the point sources of the original (red, inner circle) and adjoint field (blue, outer circle). The contours become denser in the place far from the line connecting 2 ports. The white dashed ellipse shows the range

$$\leq {R}_{0} = \frac{5}{4} {λ}_{eff} ,$$

which is used for simulations.

FIGS. 6A-6H illustrate transmission measurements. FIG. 6A illustrates a dual-pump optical setup. The 1064 nm pump laser (green trace) is split into two paths for the patterned pumping and the microlaser excitation. The signal around 1500 nm (red trace) is collected by the infrared camera. VA: variable attenuator, OBJ: objective lens, DM: dichroic mirror, PH: pinhole, FM: flip mirror, BPF: band pass filter. FIG. 6B illustrates target pumping pattern and the pattern generated in experiment. The light spot on the top of the experimental pattern is the zero-order beam from SLM, which does not affect the performance as it is far away from the center. FIG. 6C illustrates spectrum collected at an input port. FIG. 6D illustrates spectrum collected at one output port with (top line) and without (lower line) microring lasers excited. FIGS. 6E-6H illustrates images with different excitation channels. The red (boxes corresponding to I₁-I₄) and white boxes (boxes corresponding to O₁-O₄) mark the position of individual microring laser and the output grating. The yellow box indicates the whole imaginary-index-driven area.

FIG. 7 provides a flow chart of the in-situ training. The initial pattern can be an arbitrary connection between the inputs and the outputs. In each epoch, the inputs and outputs related to all the samples in the dataset are measured. The pumping pattern is updated based on the measurements in the epoch until the accuracy reaches the target.

FIGS. 8A-8B illustrate transmission controlled by the imaginary index. FIG. 8A provides an Image captured in experiments without pumping. FIG. 8B provides an image captured with a pumping pattern connecting the input and output ports. The dashed box marks the imaginary-index-driven area, and the input intensity from the microring laser is monitored by the scattering from a grating coupler (circled in boxes labeled “in”) and the output intensity is detected another grating coupler (circled in boxes labeled “out”) connected with the central area with a taper waveguide (outlined by the green dashed lines towards the “out” box). The width of the input port is 500 nm, and the width of the output port is 3 μm. FIG. 8C-8E provide simulations with different lower bound settings for the imaginary index in the regions surrounding the pumping area. The left panels show the spatial imaginary-index map, and the right panels show the simulated electric field intensity.

FIGS. 9A-9D provide a characterization of single connection enabled by the online algorithm. FIG. 9A provides a measured transmission versus total pumping power with a pattern generated by the online algorithm. The hologram in SLM was fixed during the measurement, and the pumping power was tuned by an attenuator and monitored by a power meter. FIG. 9B provides simulated transmission versus pumping level. FIGS. 9C-9D provides images captured under a pumping with a (FIG. 9C) horizontally aligned connection and a (FIG. 9D) tilted connection, indicated by the yellow dashed lines.

FIGS. 10A-10D provide an evaluation of device performance with different pumping resolutions. FIG. 10A provides pumping patterns with different resolutions. The red (left side) arrows and black (right side) arrows mark the positions of the input and output ports. FIG. 10B provides an image captured with an excitation at the top input in experiments. The orange dashed boxes mark the imaginary-index-driven area and white boxes denote the output ports. FIG. 10C provides a measured power contrast ratio (without iterative optimization) as a function of pumping resolution. FIG. 10D provides a simulated transmission matrix fidelity (with pattern optimization algorithm applied) as a function of pumping resolution (individually controllable pixel size for the imaginary index distribution).

FIGS. 11A-11C illustrate a transmission matrix reconfiguration (compared to FIGS. 3A-3F) for node-free non-blocking optical switching. FIG. 11A illustrates a pumping pattern. FIG. 11B provides a target transmission matrix. FIG. 11C provides a measured transmission matrix.

FIGS. 12A-12D illustrate in-situ training of a vowel recognition optical network. FIG. 12A provides signal encoding for one vowel audio file. The left panel shows the image captured where the input feature vector is encoded as the intensities in each channel, which are measured by the light emitted through the scatter inside each dashed box. The right panel compares the measured input (exp) and the target (target). FIG. 12B provides encoding fidelities for all 128 vowel data. The average fidelity is 99.93% shown by the black dashed line. FIG. 12C provides the evolution of loss function and training accuracy during the in-situ training process. FIG. 12D provides a comparison between the initial pumping pattern and the final one after training. The left side and right side arrows mark, respectively, the position of 8 inputs and 4 outputs.

FIGS. 13A-13B illustrate wavelength dependency. FIG. 13A illustrates a simulated transmission as a function of signal wavelength from 1400 nm to 1500 nm. FIG. 13B illustrates a measured bulk PL spectrum from 1300 nm to 1600 nm.

FIGS. 14A-14C illustrate a measured nonlinear output-input response. With the total pumping intensity increases, the nonlinear phase of the system changes from the (FIG. 14A) saturable loss (convex) to (FIG. 14B) transparency (linear) and finally to (FIG. 14C) saturable gain (concave). The measured power is normalized according to the saturation power of the infrared camera.

FIG. 15 illustrates a block diagram illustrating an example computing device.

### DETAILED DESCRIPTION OF ILLUSTRATIVE EMBODIMENTS

The present disclosure can be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise. As used in the specification and in the claims, the term “comprising” can include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

As used herein, approximating language can be applied to modify any quantitative representation that can vary without resulting in a change in the basic function to which it is related. Accordingly, a value modified by a term or terms, such as “about” and “substantially,” can not be limited to the precise value specified, in some cases. In at least some instances, the approximating language can correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” can refer to plus or minus 10% of the indicated number. For example, “about 10%” can indicate a range of 9% to 11%, and “about 1” can mean from 0.9-1.1. Other meanings of “about” can be apparent from the context, such as rounding off, so, for example “about 1” can also mean from 0.5 to 1.4. Further, the term “comprising” should be understood as having its open-ended meaning of “including,” but the term also includes the closed meaning of the term “consisting.” For example, a composition that comprises components A and B can be a composition that includes A, B, and other components, but can also be a composition made of A and B only. Any documents cited herein are incorporated by reference in their entireties for any and all purposes.

The present invention provides improved systems and methods for lithography-free programmable integrated photonics. The invention creates an unprecedented lithography-free paradigm for integrated photonics, targeting dynamic control of spatial-temporal modulations of imaginary index on an active semiconductor platform without the need for lithography, which is completely distinguished from the state-of-the-art where photonic functions are predefined by lithographically introduced complicated structures.

The data throughput can be further increased by applying the wavelength degree of freedom for optical computing. The lithography-free, imaginary-index driven devices support a broad bandwidth over 14 THz in the communication wavelength around 1500 nm. Wavelength multiplexers and demultiplexers can also be integrated with various embodiments discussed herein to utilize the broadband gain spectrum.

Together with the ultrafast optical response of the semiconductor materials, the data capacity of the imaginary-index-driven devices can potentially reach an extremely high throughput with a relatively small footprint. Moreover, the carrier dynamics in the active semiconductor platform will be further explored to create optical nonlinearity. The successful realization of optical nonlinearity in integrated photonics could further enhance the neural-photonic computing acceleration for data-intensive applications.

Meanwhile, the number of input and output channels will also be increased dramatically. An expected milestone would be a larger device with wavelength multiplexing/demultiplexing techniques.

Various embodiments further demonstrate dynamic control of the imaginary-index modulation, and reconfigures the global photonic network connectivity for on-chip in-situ machine learning. Programmability and multi-functionality, intrinsically arising from lithography-free characteristics of the present technology, can deploy a new paradigm for system-level integrated photonic networks to conduct and reconfigure complex computation algorithms, accelerating the information processing speed to sustain long term performance requirements. With the broadband gain spectrum and the ultrafast optical response of the semiconductor materials, the data capacity of the imaginary-index-driven devices can potentially reach a very high throughput. Moreover, beyond the demonstrated reconfigurable computing in the linear regime, the carrier dynamics in the active semiconductor platform can be further explored to create optical nonlinearity, for example, with saturable gain where the imaginary-index modulation becomes nonlinear with regard to photon density once the carriers are depleted. The successful realization of optical nonlinearity in integrated photonics could further enhance the neural-photonic computing acceleration for high-throughput, data-intensive applications.

Present embodiments are completely distinguishable from traditional, state-of-the-art structures, through an integrated photonic processor targeting dynamic control of spatial-temporal modulations of imaginary index on an active semiconductor platform without the need for lithography. Various embodiments demonstrate an imaginary-index-driven methodology to tailor optical gain distributions to rationally execute prescribed optical responses and configure desired photonic functionality to route and switch optical signals. Leveraging real-time reconfigurability, embodiments realize photonic neural networks with extraordinary flexibility, performing in-situ training of vowel recognition with high accuracy. Programmability and multi-functionality, intrinsically arising from lithography-free characteristics, can conduct and reconfigure complex computation algorithms, accelerating the information processing speed to sustain long-term performance requirements.

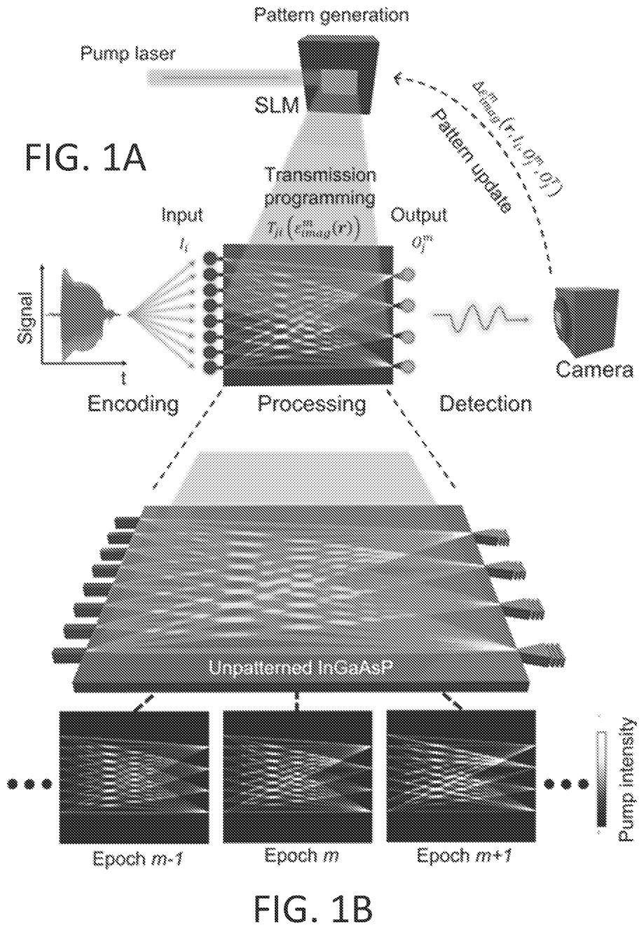

Moreover, embodiments create exceptional field programmability and functionality from a global perspective by full elimination of connecting nodes due to its lithography-free nature. The present work delivers a brand new and ultra-flexible integrated photonic paradigm for reconfigurable networking and computing, with great potential to process large, non-local datasets with high throughputs. FIG. 1 illustrates the concept of a lithography-free integrated photonic processor, referred to as the central unpatterned area where dynamic control and spatial patterning of optical gain on an active III-V semiconductor platform²⁵⁻²⁷ conduct an arbitrarily field-programmable photonic network. The absence of any predefined features on this unpatterned wafer of InGaAsP multiple quantum wells provides the convenience of reconfigurability, by which optical coding of patterned pumping light defines the gain-loss distribution and thus spatially modulates the imaginary index, instead of the real-index modulation by lithographically defined features. Note that intrinsic material losses associated with unpumped areas correspond to the imaginary index being negative, while optical gain arising from active pumping turn the imaginary index positive, with the modulation strength of −0.1≤ε_{imag}≤0.03 precisely controlled by the intensity of pumping light^{28,29} (see, e.g., Sections 1 and 2). The algorithm-optimized spatial imaginary-index distribution forms an on-chip imaginary-index-driven photonic network that directly connects inputs with outputs, performing optical information processing according to the desired matrix-vector multiplication

$$( i . e . , {O}_{j} = {\sum }_{i} {T}_{ji} \cdot {I}_{i} ,$$

where Tⱼᵢ denotes power transmission from input port i to output port j), where the signals are encoded by the light power in each input and output channel. The virtue of the generated imaginary-index-driven network is its intrinsic reconfigurability associated with the convenient pattern generation and real-time transformation by optical coding using a spatial light modulator (SLM). In this scenario, the measurement results of the output light power are monitored in a real-time manner and the feedbacks from the detection are delivered to the SLM to update the pumping pattern either for self-error-correction or in-situ training (FIG. 1). Although there are typically a very large number of variables to be carefully designed and tuned layer-by-layer in a large-scale network architecture, a promising feature in this lithography-free, reconfigurable integrated photonic processor is that all the information needed for pattern optimizations are the measured power from each input (Iᵢ) and output port

$$( {O}_{j}^{m} ) ,$$

for epoch m together with the pre-defined target output

$$( {O}_{j}^{T} ) .$$

This unique feature of global input-output connections significantly simplifies the algorithm needed for pattern reconfiguration, thereby enabling simulation-free, real-time reconfigurable computing acceleration for in-situ training.

To efficiently generate and optimize the spatial imaginary-index map for specific functionality, various examples develop novel imaginary-index-driven inverse design algorithms (assuming the real index remains the same in the modulation region): an offline algorithm and its derived online algorithm, both following the gradient-descent methods. In both algorithms, a general loss function is defined for the target function and the algorithms minimize the loss function by estimating the gradient over the variables, which is the spatial imaginary-index profile. FIG. 2A illustrates the two algorithms in a flow chart form for the realization of an arbitrary power transmission matrix between the input and output ports. Here, with an imaginary-index-driven photonic processor (i.e., the central information processing area without any lithographically patterned features) connected with four input (I₁-I₄) and four output (O₁-O₄) waveguides, a 4×4 triangular matrix T can be chosen as a proof of concept:

$$T = ( \begin{matrix}0.25 & 0.33 & 0.5 & 1 \\ 0.25 & 0.33 & 0.5 & 0 \\ 0.25 & 0.33 & 0 & 0 \\ 0.25 & 0 & 0 & 0\end{matrix} ) \qquad ( 1 )$$

The offline algorithm (see Methods) is an inverse design^{30,31} algorithm based on the electromagnetic field simulation and the adjoint method^{32,33}. For N input channels, N parallel solvers are used to solve two-dimensional Maxwell equations under the excitation of each individual waveguide (marked by red, excitation I₃ as an example) by the finite-difference frequency-domain (FDFD) method³⁴. According to the solved field in solver i, a target-defined loss function Lᵢ is calculated, which evaluates the deviation from the target function. An adjoint field corresponding to the loss function is subsequently simulated, similarly to the adjoint method for real-index inverse design. The map of the negative gradient to the imaginary index [symbol] −dL [symbol] _3/ε_imag) is extracted from the results of these two simulations, i.e., the spatial amplitude distribution of the simulated field e₃ and adjoint field

$${e}_{3}^{adj} .$$

The final imaginary-index map Δε_{imag}(r), that conducts the transmission matrix T in the imaginary-index-driven area, is generated according to the global gradient by combining the gradient information from all N parallel solvers. Note that the algorithm does not limit the coherency of light between different input channels, but for the convenience of experimental demonstrations, examples focus on the case where the signals from different input channels are incoherent and do not have a stable phase relation. In this case both the signal and the transmission matrix are strictly positive real-valued.

The offline algorithm is precise and efficient to realize an arbitrary transmission matrix, but the device is offline during the whole process, therefore any mismatch between the simulation and the actual device can deteriorate the device performance especially when the scale of the device becomes large. To bring imaginary-index-driven computing into reality, an online algorithm must be realized in which the actual device is online for real-time measurements during the whole optimization process. Although the offline algorithm requires time-consuming simulations and is thus not suitable for real-time optimizations, its generated imaginary-index map guides the development of the online algorithm (see Methods): the field profile connecting input i with output j in the imaginary-index-driven area can be described as a series of analytical spatial maps

$${F}_{ji} ( r ) = \{ \begin{matrix}cos [ {k}_{eff} \cdot {R}_{ji} ( r ) ] & , if {R}_{ji} ( r ) \leq {R}_{0} \\ 0 & , else\end{matrix} , \qquad ( 2 )$$

where k_{eff} is the effective wavevector and Rⱼᵢ(r) is defined as Rⱼᵢ(r)=|r−rᵢ|+|r−rⱼ|−|rᵢ−rⱼ|, where rᵢ and rⱼ are the position of the corresponding input and output ports, respectively R₀ controls the spatial range of the map depending on the actual pumping pixel resolution (see, e.g., Section 3). A series of spatial maps {Fⱼᵢ(r)}, alongside the measured power at input and output channels, can yield an approximate gradient map

$$( \approx \frac{- {dL}_{3}}{{ε}_{imag}}$$

with excitation I₃, for example) in excellent agreement with the exact one

$$( \frac{- {dL}_{3}}{{ε}_{imag}} )$$

from the offline algorithm. Similarly, a global approximate gradient is achieved by the summation of all measurements results from all input channels, producing the target imaginary-index map online. Here, various examples fully exploit the aforementioned unique feature of global input-output connections in the imaginary-index-driven matrix processing area to demonstrate the simulation-free online algorithm, which enables real-time optimization for reconfigurable photonic computing and dynamic online learning.

To realize a robust performance, a combination of the two algorithms can be applied strategically, evidently validated by three numerical simulations taking different scenarios into account (FIG. 2C-2E). With the target matrix in equation (1) displayed in FIG. 2B, an almost perfect match (FIG. 2C) is achieved using the offline algorithm. However, in practical applications, the result can be deviated from the offline simulations because of a slightly mismatch of index, an imperfect generation of the pumping pattern, or any random noise. To mimic such errors in a realistic experimental scenario, various examples introduce additional random perturbations of the imaginary index with a standard deviation of 0.01 in the imaginary-index-driven area, which consequently perturbs all the matrix elements in T deviating from the original result (FIG. 2D). The online algorithm is therefore applied to successfully compensate the adverse influence of the perturbation based on only the output power, featuring the capability of real-time optimizations to revive the target matrix despite random noise (FIG. 2E).

To experimentally confirm real-time optimizations for reconfigurable photonic routing, switching, and networking using the infrastructure described herein, various examples demonstrate the generation of an arbitrary matrix processor by dynamically controlled pumping patterns with the corresponding intensity distribution equivalently translated from the imaginary-index map obtained by the inverse design algorithms. The reconfigurable imaginary-index-driven photonic processor is a 300 μm×240 μm unpatterned area, which is connected with four input and four output channels based on the InGaAsP multiple quantum wells platform (FIG. 3A). To take a full advantage of the active nature of InGaAsP, integrated microring lasers are fabricated to directly encode information for convenient signal input. In experiments, two pumping beams at the wavelength of 1064 nm are applied to perform the matrix processor (see Methods). The first pumping beam, patterned by an SLM according to the algorithm-optimized imaginary-index map, is impinged on the lithography-free, imaginary-index-driven area to define the photonic network and real-time optimize the power transmission matrix. The top and bottom regions outside the optimization area remain unpumped and hence dissipative to eliminate boundary reflections (similar to absorbing boundaries as perfect matched layers used in numerical simulations). The other separated pumping beam is focused on individual microring lasers to excite one signal channel each time. Note that while emissions of the microring lasers all occur at approximately 1500 nm, they slightly vary from one another with the detuning measured in a range of 3 nm. As a result, input signals from different channels become intrinsically incoherent with each other. On the other end, the normalized output 4×1 vector is collected for power transmission and grating couplers are implemented for efficient detection of signal output in the free space.

With the same target transmission matrix T given in equation (1) (FIG. 3B), a pumping pattern according to the offline algorithm is first generated and applied in the imaginary-index-driven matrix processing area (FIG. 3C, right panel). Although the offline simulation yields a nearly perfect transmission matrix with a fidelity

$$( f = \frac{tr ( \sqrt{{T}^{′}} \sqrt{M} )}{\sqrt{tr ( \sqrt{{T}^{′}} \sqrt{T} )} \sqrt{tr ( \sqrt{{M}^{′}} \sqrt{M} )}}$$

where M represents the measured transmission matrix, T′ denotes the transpose of T, and the square root is applied to each matrix element) over 99%, the performance in real experiments does not match the target (see, e.g., Section 4), yielding a fidelity of only 93% and thus leaving a sufficient space for online optimizations (FIG. 3C). To compensate the deviation, the online algorithm is applied to adjust the pumping pattern according to the measurement results in real time, leading to the increased fidelity of the measured transmission matrix to 99.2% after 9 iterations (FIG. 3D). With the accumulated optimization of the pumping distribution in the real-time optimization process (FIG. 3E, top panels), the evolution of the transmission matrix shows its gradual convergence to the target (FIG. 3E, bottom panels). The improvement from the measurement feedback convincingly demonstrates the validity the online algorithm, which is critical to prevent error cascading in a large-scale network. Since the matrix processor is fully programmed by dynamic control of the pumping pattern and its functionality does not rely on any lithography-patterned structures, the imaginary-index-driven optical coding scheme can be arbitrarily reconfigured and optimized in a real-time manner for reconfigurable computing acceleration.

To exploit the demonstrated dynamic reconfigurability for computing acceleration to handle data-intensive tasks, various embodiments perform in-situ machine learning, in which the pumping pattern is online trained to real-time reconfigure the network connectivity or weight. A classical 4-vowel (‘er’, ‘iy’, ‘oa’, and ‘ae’) classification task is applied to demonstrate the concept. The dataset³⁶ consists of the speeches of different vowels from both males and females, divided into a training set and a testing set with each containing 64 audio files. A fully connected neuro-photonic network is executed using an imaginary-index-driven photonic processor with an unpatterned, active area of 500 μm×324 μm (FIG. 4A). Despite a large number of redundant information in the audio files, eight prominent features in frequency bands associated with the vowels are selectively extracted to accurately represent the training database, to be encoded as input signals. In the input layer, any 8 out of 12 microring lasers can be excited, where the strength of each feature is encoded as the power of the corresponding microring laser emission precisely controlled by its pumping intensity. An iterative method is applied to guarantee the power of the eight microring lasers perfectly matches the features in the dataset, with an average encoding fidelity of 99.9% achieved in experiments (see, e.g., Section 5). In the output layer, the four vowels are categorized with output channels 1-4 (any 4 out of 12) corresponding to ‘er’, ‘iy’, ‘oa’, and ‘ae’, respectively. The predicted class is directly indicated by the highest intensity among the outputs.

Distinguished from the computer-trained target matrix, dynamic online learning is to process the training dataset with iterative measurement feedbacks to in-situ identify the most appropriate matrix for the classification task of vowel recognition. Therefore, instead of starting with the pumping pattern by the offline algorithm, the photonic processor is initialized with a symmetric pumping pattern that connects all input and output channels, which is subsequently in-situ trained using the online algorithm. In the m-th training epoch, the error

$${err}_{j , k}^{m}$$

between the network prediction (measured outputs) and the ground truth (target scenario) can be calculated at output j for training data k, by which the variations of all the matrix elements needed for the next epoch can be in-situ updated according to the error backpropagation:

$$Δ {T}_{ji}^{m} ∝ - \frac{\partial L}{\partial {T}_{ji}^{m}} = - {\sum }_{k} {I}_{i , k} \cdot {err}_{j , k}^{m} .$$

Here, L is the loss function defined in a mean square error format and I_{i,k} denotes the measured input power at input i for training data k. Consequently, with the preloaded analytical spatial maps {Fⱼᵢ(r)} in equation (2), the updated imaginary-index map can be online obtained in real time:

$${Δε}_{imag}^{m} ( r ) = - δ \frac{\partial L}{\partial {ε}_{imag}^{m} ( r )} = - δ {\sum }_{i , j} \frac{\partial L}{\partial {T}_{ji}^{m}} \frac{\partial {T}_{ji}^{m}}{{ε}_{imag}^{m} ( r )} = - δ {\sum }_{i , j , k} {I}_{i , k} \cdot {err}_{j , k}^{m} \cdot {F}_{ji} ( r ) , \qquad ( 3 )$$

which guides the dynamic reconfiguration of the pumping pattern for the next in-situ training epoch. Here, 6 is a constant learning rate. In this scenario, the optical network is in-situ trained without the physically implemented error backpropagation and its associated complex algorithms (see Methods). With the dynamic online learning, the device discussed herein demonstrates high accuracy in vowel recognition (FIG. 4B). After 65 training epochs to achieve a classification accuracy of 98.4% for the training dataset, the device achieves a high accuracy of 93.8% for the testing dataset, in contrast to the initial accuracy of only 15.6%. More specifically, FIGS. 4c and 4d show the distribution of measured optical signals in the input and output layers, respectively, exhibiting the high performance of in-situ dynamic learning for this classification task. In the input layer, all four classes of data are mixed and overlapped with each other, making the recognition task challenging. In particular, vowels ‘oa’ (blue) and ‘ae’ (gray) have a significant overlap in the parameter space of input features, which leads to a small overlap (but distinguishable) between them in the output layer. In parallel, vowels ‘er’(red) and ‘iy’(green) are completely separated in the output layer. The performance of the classification results is quantitatively demonstrated based on the confusion matrix of the testing dataset (FIG. 4E), which defines the percentage of correctly identified vowels along its diagonal and the percentage of incorrectly identified vowels in the off-diagonal terms. The strong diagonal distribution demonstrates the impressive performance, showing the potential to handle data-intensive computing tasks in real time. The most unique feature associated with the in-situ learning process, in contrast to any ex-situ ones, is that the gradient information that drives the weight update is directly measured and extracted from the real device. Hence, this real-time optimization process, with the device in the loop, can assure high-performance computing in a large-scale network, instead of relying on either perfect fabrication or computationally expensive complicated modeling.

Various examples have demonstrated a new lithography-free integrated photonic processor, where the lithography-free nature provides convenience of reconfigurability demonstrated by optical coding of spatial-temporal modulations of the imaginary index on an active semiconductor platform. Dynamic control of the imaginary-index modulation reconfigures the global photonic network connectivity for in-situ machine learning. Note that although the photonic processor itself does not require any lithographically defined features inside, its connections with other devices for signal input/output (such as microring lasers and grating couplers in experiments discussed herein, which can be potentially replaced by lensed fiber systems) can still require elementary-level lithography. Nevertheless, it is worth emphasizing that optical signals are fully on-chip processed in a lithography-free core driven by spatial-temporal control of imaginary index. In this scenario, hence, the need for high-precision lithography in integrated photonics can be drastically reduced. With the gain spectrum of the active semiconductor over 100 nm (see, e.g., Section 6), the imaginary-index-driven photonic processor holds the potential for broadband operations. Moreover, beyond the demonstrated reconfigurable computing in the linear regime, the carrier dynamics in the active semiconductor platform can be further explored to create optical nonlinearity³⁷, for example, with saturable gain or loss where the imaginary-index modulation becomes nonlinear with regard to photon density (see e.g., Section 7). The successful realization of optical nonlinearity in integrated photonics could further enhance the neural-photonic computing acceleration for high-throughput, data-intensive applications.

### Methods

### Offline Algorithm

For a processor with N input ports, N parallel solvers work simultaneously and each of them simulates a case with one excited channel. The total loss function is defined as

$$L = {\sum }_{i = 1}^{N} {L}_{i} = {\sum }_{i = 1}^{N} \frac{1}{2} {\sum }_{j} {( {O}_{j , i} - {T}_{ji} {I}_{i} )}^{2} , \qquad ( 4 )$$

where O_{j,i} is the power in output port j when only input port i is excited, and Tis the target transmission matrix. To find a spatial imaginary-index-modulation that gives the target transmission, the gradient information

$$\frac{\partial L}{\partial {ε}_{imag} ( r )}$$

is critical. The adjoint method used in the real-index inverse design is adapted for an imaginary-index-driven photonic processor for the gradient extraction. First, the two-dimensional Maxwell equations are solved to obtain the field eᵢ(r), where the sources are incorporated using the total-field/scattered field (TF/SF) formulation. The fields are then used to calculate the derivative ∂L/∂eᵢ(r), which is applied as the excitation source for the adjoint field

$${e}_{i}^{adj} ( r )$$

following the Maxwell equations in the same system:

$$μ\_ 0 \hat{} ( - 1 ) ∇ \times ∇ \times e\_i \hat{} adj ( r ) - {ω}^{2} {ε}_{0} {ε}_{r} ( r ) e\_i \hat{} adj ( r ) = - \partial L / ( \partial e\_i ( r ) ) , \qquad ( 5 )$$

where εᵣ (r) is the complex relative permittivity. Once the original and adjoint fields are obtained, the gradient in one solver is given by

$$\frac{\partial {L}_{i}}{\partial {ε}_{imag} ( r )} = 2 {ω}_{0}^{2} {ε}_{0} Im \{ {e}_{i}^{adj} ( r ) {e}_{i} ( r ) \} , \qquad ( 6 )$$

where Im takes the imaginary part of the complex value. The global gradient is calculated by the summation of the results from all parallel solvers:

$$\frac{\partial L}{\partial {ε}_{imag} ( r )} = {\sum }_{i = 1}^{N} \frac{\partial {L}_{i}}{\partial {ε}_{imag} ( r )} . \qquad ( 7 )$$

To reduce the number of evaluations of the original and adjoint fields, the imaginary index is updated using a limited-memory Broyden-Fletcher-Goldfarb-Shanno (LBFGS) optimization algorithm that improves the convergence rate without significantly increasing the memory requirements by providing an approximate inverse Hessian matrix³⁸. The simulations are performed in a processor with a scale of 150 μm×90 μm. The grid size used for the FDFD method is 100 nm×100 nm for the signal with a free space wavelength of 1500 nm. The pixel resolution of the spatial imaginary-index-modulation is limited to 2 μm×2 μm, consistent with the feasibility in these experiments (see, e.g., section 3).

### Online Algorithm

Different from the real-index inverse design, present embodiments apply approximations to the imaginary-index-driven inverse design to significantly simplify the gradient extraction. Starting from the precise adjoint method, the excitation source of the adjoint field at the output port j is

$${b}_{i}^{adj} ( {r}_{j} ) = - \frac{\partial {L}_{i}}{\partial {e}_{i} ( {r}_{j} )} = - \frac{\partial {L}_{i}}{\partial {O}_{j , i}} \frac{\partial {O}_{j , i}}{\partial {e}_{i} ( {r}_{j} )} ∝ - \frac{\partial {L}_{i}}{\partial {O}_{j , i}} {e}_{i}^{*} ( {r}_{j} ) , \qquad ( 9 )$$

where the output power at port j is

$${O}_{j} ∝ {\sum }_{{r}_{j}} {e}_{i}^{*} ( {r}_{j} ) {e}_{i} ( {r}_{j} ) .$$

The precise gradient can be divided into an amplitude term and a phase term:

$$\frac{\partial L}{\partial {ε}_{imag} ( r )} ∝ Im \{ {e}_{i}^{adj} ( r ) \cdot {e}_{i} ( r ) \} = \vert {e}_{i}^{adj} ( r ) \cdot {e}_{i} ( r ) \vert \cdot sin [ {φ}_{i}^{adj} ( r ) + {φ}_{i} ( r ) ] , \qquad ( 10 )$$

where

$${φ}_{i}^{adj}$$

and φᵢ(r) are the phase of the adjoint field and the original field, respectively. The sine term for the phase is important, as it controls the sign of the value thus determines to the imaginary index to get either gain or loss for the next iteration. At the position of the output ports, the phase relation of these two fields is fixed since the excitation source of the adjoint field is proportional to the conjugation of the original field. By considering the phase difference of

$$- \frac{π}{2}$$

between the excitation and the field, the present examples reaches

$$sin [ {φ}_{i}^{adj} ( r ) + {φ}_{i} ( r ) ] = \pm 1 , \qquad ( 11 )$$

where the sign on the right side keeps the same as the sign of

$$\frac{\partial {L}_{i}}{\partial {O}_{j , i}} .$$

Due to the dimensions of the device of about two orders of magnitude greater than the wavelength and the relatively weak imaginary-index-modulation, point-source approximations, located at the position rᵢ and rⱼ marked by red inner and blue outer circles in FIG. 5A, can be safely applied for the incidence of the original and adjoint field. In this way, the phase term can be approximated as

$$sin [ {φ}_{i}^{adj} ( r ) + {φ}_{i} ( r ) ] = \pm cos [ {k}_{eff} \cdot R ( r ) ] , \qquad ( 12 )$$

where k_{eff} is the effective wavevector and R(r) is defined as R(r)=|r−r_i|+|r−r_j|−|r_i−r_j|. Since the excitation of the original field is normalized and the adjoint field intensity is proportional to the error

$${err}_{j , i} = \frac{\partial {L}_{i}}{\partial {O}_{j , i}} = ( {O}_{j , i} - {T}_{ji} {I}_{i} ) ,$$

which can be calculated by the measured output and input power in experiments, the gradient is simplified as

$$\frac{\partial L}{\partial {ε}_{imag} ( r )} \approx C {\sum }_{j} {err}_{j , i} \cdot cos [ {k}_{eff} \cdot R ( r ) ] , \qquad ( 13 )$$

where C is a constant. The cosine term gives a series of elliptical contours lines (FIG. 5B). By considering the actual pumping resolution, the sparse pattern near the line connecting the corresponding input and output ports becomes notable. A spatial map

$${F}_{ji} ( r ) = \{ \begin{matrix}cos [ {k}_{eff} \cdot {R}_{ji} ( r ) ] & , if {R}_{ji} ( r ) \leq {R}_{0} \\ 0 & , else\end{matrix} \} \qquad ( 14 )$$

is finally used to describe the approximate gradient:

$$\frac{\partial {L}_{i}}{\partial {ε}_{i m a g} ( r )} \approx C {Σ}_{j} e r {r}_{j , i} \cdot {F}_{ji} ( r ) , \qquad ( 15 )$$

Since the spatial maps {Fⱼᵢ(r)} are analytical and can be preloaded, the system can be optimized based only on the measurements of the light power in each port without the application of the computationally expensive offline algorithm. Various examples utilize the optimization process using the offline algorithm, where the simulated output powers at each port are used to mimic the measurements. A range parameter

$${R}_{0} = \frac{5}{4} {λ}_{eff}$$

is used (marked by the white dashed ellipse in FIG. 5B). Although the convergent speed is slower than the offline algorithm, a perfect performance is also reached at the end, convincingly validating the performance of the online algorithm for the optimization.

### Sample Preparation

A wafer consisting of 220 nm-thick InGaAsP multiple quantum wells on an InP substrate was used to fabricate the lithography-free photonic processor and its connected signal input/output modules. On this active semiconductor platform, various embodiments performed electron-beam lithography (EBL) to pattern the sample including the central lithography-free area as well as the microlasers for signal input and the grating couplers for signal output. Hydrogen silsesquioxane (HSQ) solution in methyl isobutyl ketone (MIBK) was used as a negative resist. After exposure, the wafer was developed using tetramethylammonium hydroxide (TMAH) solution (MFCD-26) and rinsed in deionized water. The exposed and developed resist thus served as a mask for the subsequent inductively coupled plasma reactive ion etching (ICP-RIE) by BCl₃:Ar plasma. After the dry etching of InGaAsP, the remaining resist was removed by immersing the sample in buffered oxide etchant (BOE). A 3 μm-thick cladding layer of silicon nitride (Si₃N₄) was then deposited on the patterned structures alongside the unpatterned main processor area, using plasma enhanced chemical vapor deposition (PECVD). Finally, the sample was bonded to a piece of glass slide, and the InP substrate was selectively removed by a wet etching with a mixture of hydrochloride acid (HCl) and phosphoric acid (H₃PO₄).

### Measurements of the Transmission Matrix

The optical setup is shown in FIG. 6A, where the pumping beam is from a nanosecond pulse laser at the wavelength of 1064 nm. The pump is divided into two paths by a beam splitter. The one modulated by SLM 1 is used to generate the pattern that programs the transmission matrix of the processor with an average pumping power of 1.5 mW. A toolbox (OTSLM³⁹) for structured light methods is used to generate the hologram for the target pumping pattern based on the Gerchberg-Saxton (GS) algorithm. The numerical aperture (N.A.) of the 10× objective is 0.45, which guarantees the pumping pixel resolution of 2 μm (FIG. 6B). The other path modulated by SLM 2 is for the microring laser excitation and input signal encoding. The radius and widths of the microring lasers are designed to lase at a single longitudinal mode around 1500 nm. The typical spectrum collected at one input channel is shown in FIG. 6C. The lasing wavelengths of the microrings for different channels are slightly detuned with a measured range of 3 nm. The signal emitted from the chip is collected by a 20× objective and the PL is first filtered by the bandpass filter centered at 1500 nm with a bandwidth of 12 nm. The intensities of the output ports are captured by an infrared CCD camera. The image with the only pumping pattern from SLM1 applied (no microlaser is excited) is captured as a reference. A reference subtraction helps eliminate the influence of the PL. The PL subtraction method is confirmed by the spectrum collected at one output port (FIG. 6D), where the off-resonant PL signal remains the same level with and without the input signal from a microlaser. To operate in a real time manner, the signals are recorded by the camera rather than the spectrum measurements during the online optimization process. FIG. 6E-6H are the images when the microlasers for different input channels are excited one by one under the same pumping pattern optimized by the online algorithm. The power in each output port is integrated over the area marked by the white dashed boxes and the output vector is then normalized over all output ports. The normalized values are used as the transmission matrix elements instead of the absolute transmission defined as the power ratio of output to input. The transmission matrix elements extracted from the 4 images are shown in FIG. 3 in the main text (FIG. 3E, iteration 9).

### In-Situ Training for Vowel Recognition

128 audio data for 4 vowel classes from different males and females are randomly picked from the vowel dataset. The data is randomly divided into a training set and a testing set. The audio files were recorded with a sampling rate of 16 kHz. To remove the redundant information, the bark spectra are extracted by a feature extraction function from the MATLAB Audio Toolbox. The 8 features from the spectrums are used as the input vector to the processor.

In the in-situ training for vowel recognition in experiments, the loss function for the training is

$$L = \frac{1}{2} {\sum }_{k} {\sum }_{j} e r {r}_{j , k}^{2} ,$$

with the error defined by

$${err}_{j , k} = {O}_{j , k} - {O}_{j , k}^{T} .$$

### Here O_{j,k} and

$${O}_{j , k}^{T}$$

are the measured and target power intensities in output port j for training audio data k. The target is defined as

$${O}_{k , j}^{T} = β + ( 1 - 4 β ) {δ}_{{jl}_{k}} ,$$

where lₖ is the true label for the training data k, and β is a constant. For one layer of the linear matrix operation, the output contrast for different vowel classes is expected not to reach a significant high level, so a bias of β=0.15 is introduced to make the training focus more on the overall performance. Similar to the optimization of the power transmission matrix, the online algorithm is applied to update the imaginary-index according to only the measurement results of the light power at inputs and outputs after each training epoch. Note that the pumping pattern is only updated according to the training set and the testing set is only applied to record the accuracy in each epoch. The in-situ training process can be described by the flow chart shown in FIG. 7. The training is performed until the training accuracy acc reaches a desired target aₜ.

### 1. Imaginary Index and Optical Gain/Loss of InGaAsP

The lithography-free reconfigurable integrated photonic processor is developed on an active semiconductor platform with optical gain: InGaAsP multiple quantum wells. Without external pumping, the device is intrinsically lossy at the working wavelength around 1500 nm. Under external pumping, the intrinsic loss can be compensated, and the optical gain can be obtained with stimulated emission.

Mathematically, optical gain and loss can be analyzed by introducing an imaginary part in the refractive index, i.e., n=nᵣₑₐₗ+in_{imag}. In a simplified scenario, considering a plane wave propagating with a free space wavevector of k₀ in the x direction provides:

$$E = {E}_{0} {e}^{i ( - n {k}_{0} x + ω t )} = {E}_{0} {e}^{i ( - {n}_{r e a l} {k}_{0} x + ω t ) - γ x} , \qquad ( 16 )$$

where γ is the decay rate of the electric field in the x direction and can be represented using the imaginary refractive index as:

$$γ = - {n}_{i m a g} {k}_{0} . \qquad ( 17 )$$

The relation between the decay rate γ and the imaginary relative permittivity ε_{imag} can be obtained by simply applying ε=n². In this way, the modal loss inside a single mode waveguide has been estimated in previous work^{1,2}. Accordingly, in simulations, a hard boundary can be set for the bulk imaginary permittivity of ε_{imag,min}=−0.1 hich corresponds to a bulk intrinsic loss of around 600/cm.

Experiments can characterize the transmission of guided light with and without pumping in a device with a length of 100 μm (FIG. 8). Limited by the signal-to-noise ratio of detection, the power transmission between the output port (white outline) and the input port (red outline) for the unpumped case (i.e., intrinsic material loss) is lower than 0.002, corresponding to an imaginary index ε_{imag}<−0.05 (by a rough estimation neglecting the influence of diffraction). With a pumping pattern linking the input and output ports (i.e., optical gain), the transmission can reach 5.1 and above.

It is important to note that the performance of exemplary devices are not sensitive to the absolute value of ε_{imag,min} confirmed by the simulations shown in FIG. 8C-8E. In these simulations, the center gain areas have the same imaginary index arising from the optical gain, but different losses are introduced at the regions outside the pumped area with different imaginary indices of −0.05, −0.1, and −0.15 (the left panels). The simulated electric fields (the right panels) show no difference with respect to the intensity distribution in the area and around the output port. This feature is indeed unique to the non-Hermitian optical systems, which can be explained by the adjoint field method: The gradient is extracted by the multiplication of the original electric field and the adjoint field. Since both of them are solved under the same system with the imaginary index, the gradient (proportional to the multiplication of the intensities of the two fields) for the lossy regions becomes insignificant compared to the gain regions, making the system insensitive with the lossy region as long as the loss is sufficient to eliminate the crosstalk. The higher bound of the imaginary index of 0.03 (gain) is also confirmed by the simulations since they give a power transmission around 5.0 for the 100 μm length device, which is consistent with the experimental results. In all offline simulations, the limit of the imaginary index in simulations can be set to be −0.1≤ε_{imag}≤0.03.

2. Characterization of Power Transmission with Horizontally Aligned and Tilted Connections

Benefiting from the non-Hermitian nature of the imaginary-index-driven system, the device is not limited to perform only unitary matrices. More importantly, the optical gain from the material enables a large range of transmission elements. Various examples can experimentally measure the power transmission from an input port to an output port as a function of applied pumping energy in the scenarios of both horizontally aligned and tilted input-output connections. FIG. 9A shows the evolution of transmission between two horizontally aligned ports (FIG. 9C) measured in a 500 μm device. A significant 3× signal enhancement is observed with a high pumping power (but below the damaging threshold of InGaAsP), which agrees with the simulation result. Note that in simulations, the imaginary index is directly used instead of the pumping power tuned in experiments, so a pumping level α (0≤α≤1), corresponding to the imaginary index range, is introduced to represent the imaginary index generated by the online algorithm in the system:

$${ε}_{i m a g} ( r ) = max \{ {ε}_{imag , min} , [ {ε}_{imag , min} + α ( {ε}_{imag , {max}^{-}} {ε}_{imag , min} ) {F}_{j i} ( r ) ] \}$$

that the pumping level (or imaginary index) is not linearly proportional to the pumping power in experiments, so when the clear signal is observed beyond the noise (i.e., at −0.2 mW pumping), the corresponding pumping level is already approximately 0.9 according to the simulations (FIG. 9B). This characterization also helps to calibrate the pumping power with the actual pumping level. Here, it is noted that pumping power in FIG. 9A is the actual power of the pumping laser, but only 19% of pumping light is absorbed by the material corresponding to a power range from 0 to 0.076 mW.

Various examples utilized measurements for the cases with both horizontally aligned (FIG. 9C) and tilted connections (FIG. 9D). A transmission range from 0 (0.002 considering the noise floor) to >3 are observed for both cases with nearly the same pumping energy ranges. In both cases, the examples experimentally confirmed guided light propagation from the input to the desired output.

3. Device Performance with Different Pumping Resolution

For the experiments shown in the manuscript, a 2 μm pumping pixel resolution is achieved, which is applied to demonstrate the matrix-vector multiplication and also the in-situ training. In general, a high pumping pattern resolution offers better device performance for a small device, mainly because the channel crosstalk can be well reduced with a precise pumping pattern. However, for large devices (e.g., the dimensions larger than 100 μm, similar to what is seen in experiments), the device performance becomes relatively insensitive to the pumping resolution, as the distance between outputs and inputs are long enough to avoid the undesired connections.

Various examples can also theoretically estimate the resolution requirement according to the pattern {Fⱼᵢ(r)} provided by the online algorithm (see Methods). The spatial function Fⱼᵢ(r) is a cosine function oscillating from −1 to 1, where the spatial contour lines are ellipses. On the line connecting input i with output j (Rⱼᵢ(r)=0), there is Fⱼᵢ(r)=1, so the semi-minor axis length of the first Fⱼᵢ(r)=−1 contour (that is

$${R}_{j i} ( r ) = \frac{{λ}_{eff}}{2} )$$

indicates the minimum requirement for a good performance. Here, the semi-minor axis length is equal to

$${b}_{1} = \frac{\sqrt{d {λ}_{eff}}}{2} ,$$

where d is the distance between the input and the target output port. For a device of 500 μm length, b₁≈8.6 μm, which indicates a good performance with a resolution better than this value. Note that the mathematical expression of b₁ effectively supports the scalability of the device. When the device is scaled up, the resolution requirement, proportional to \sqrt{d}, can be further reduced.

To confirm the resolution intolerance of various devices, various examples experimentally characterize the device performance with different pumping pixel resolutions. Here, the pumping pattern (FIG. 10A) for the crossed connection in a 2×2 system is generated by applying the online algorithm, but without error-correction iterations, to focus on the influence of the resolution r. In experiments, the pumping pixels are approximately circular dots with a dot-dot distance of r, which defines the pumping resolution. The radius of each spot is also tuned to be approximately r. All pumping resolutions from 2 μm to 10 μm shown good contrast when the light is launched in one input port (top port in FIG. 10B). The power ratio between the desired output to the undesired port (i.e., O₂ to O₁) can be used to evaluate the performance shown in FIG. 10C. Although the power ratio drops when the resolution is tuned from 2 μm to 10 μm, the result still maintains a high contrast above 12 dB, which can make the online error correction methods still efficient. A simulation (FIG. 10D) validates that despite the decrease of the resolution from 2 μm to 10 μm the device still yield high fidelity for matrix-vector multiplications after the patterns are optimized by the iterative algorithms. Even with the 10 μm resolution, the device reaches a final transmission fidelity over 98%.

Note that the pixelized pumping pattern with a lower resolution (FIG. 10A, bottom) can introduce relatively sharper edges in the imaginary-index modulation. Although similar sharp edges in a real-index waveguide could cause significant scattering losses, the scattering loss due to the pixelized pumping is not pronounced in devices because of intrinsically weak gain/loss contrast: the dynamic range of the imaginary part of the permittivity in present examples (Δε_{imag}=0.13) is much weaker than that in a real-index waveguide (e.g., on an SOI platform Δεᵣₑₐₗ=ε_{Si,real}−ε_{SiO}_{₂}_{,real}≈9.7). Moreover, in contrast to an abrupt index transition, the algorithm-generated pumping pattern features gradually varying intensity which corresponds to a relatively slow variation in terms of the imaginary index, which is expected to further reduce the scattering loss. Additionally, note again that light propagation naturally experiences amplifications along the gain-defined path, which further assures a good signal-to-noise ratio from input to output ports.

### 4. Non-Blocking Optical Switch by the Offline Algorithm and its Limitations

For a simple function, for example, an arbitrary non-blocking optical switch, where each input is connected to only one output, the offline algorithm itself already gives a very high fidelity over 98% (FIG. 11). For more complicated transmission matrix, the performance of the pumping pattern designed only by the offline algorithm decreases. The carrier diffusion inside the material, imperfect holograms, the slight distortion caused by the imaging system, and other random noise can make the results deviate from the simulations. By applying the online algorithm, most of the deviations can be compensated except for the imperfect holograms. The phase-only modulation from the SLM cannot generate a perfect pattern, because of the inevitable remaining errors in the GS algorithm, which is small but random in each hologram generation. Consequently, a small oscillation of the loss function appears during the online algorithm optimization. In general, the fidelity of the transmission matrix can usually be optimized to more than 99% in less than 10 online iterations.

### 5. Data Encoding and In-Situ Training for Vowel Recognition

Experimentally, to encode the input vector, SLM 2 (setup shown in FIG. 6A) is used to adjust the pumping intensity between the rings. A simple gradient descent algorithm is used to optimize the microlaser pumping according to the real-time feedback from the camera until an acceptable encoding error is achieved. The optimized holograms for inputs are saved and used in the whole training process. FIG. 12A shows the image of one encoded input and the comparison between the target and measured intensity distribution over 8 input channels. Similarly, various examples can also use a fidelity:

$$f = \frac{{\sum }_{i} \sqrt{{t}_{i} {m}_{i}}}{\sqrt{{\sum }_{i} {t}_{i}} \sqrt{{\sum }_{i} {m}_{i}}} \qquad ( 19 )$$

to evaluate the encoding performance, where tᵢ and mᵢ are the target and measured power in input port i. The average fidelity of the whole dataset is 99.93% (FIG. 12B).

With all data encoded, in-situ training can be performed. As a proof of concept, various examples demonstrate an optical neural network with 8 inputs and 4 outputs to realize a classification of 4. In the experiment for vowel recognition, only the area inside the 1^{st} zero-contour ellipse

$$( {R}_{0} = \frac{{λ}_{eff}}{4} )$$

is considered for the spatial maps {Fⱼᵢ(r)} as defined in section 3.

The evolution of the loss function during the training process is shown in FIG. 12C (green line originating ~10). The accuracy of the training dataset (black line originating ~2.5) is also shown for comparison. The non-zero loss function plateau is typical for this one-layer network. The performance is guaranteed as the loss function is convergent. FIG. 12D shows the initial pumping pattern and the final one after the in-situ training.

The device is stable and robust as the pumping power is controlled well below the damaging threshold during the entire in-situ training process. In this case, there is no degradation of performance during the whole work. In an estimation, more than 20 training processes have been conducted on the device, each with ~50 epochs done with 128 samples. If including the encoding measurements, experiments have performed the measurements more than 400,000 times without any observable performance degradation.

### 6. Wavelength Dependence and Working Bandwidth

Although the pattern is optimized at a single wavelength, it is usually not wavelength-sensitive since it does not rely on any sub-wavelength features and the device performance remains almost the same if the gain/loss contrast is high enough (see FIG. 8). A simulation of the power transmission as a function of wavelength under a fixed spatial imaginary index is shown in FIG. 13A, assuming the imaginary index is the same for all wavelengths. The change of transmission is around 30% over a wavelength range of 100 nm, therefore the imaginary-index-modulation pattern generated by the inverse design algorithm itself does not limit the working bandwidth.

In the practical case, the range of the imaginary index varies as a function of wavelength. The final working bandwidth is mainly limited by the width of the gain spectrum of the active semiconductor InGaAsP. The measured bulk photoluminescence (PL) spectrum shows a full width at half maximum (FWHM) over 100 nm (FIG. 13B), which indicates a potential working bandwidth over 14 THz.

### 7. Nonlinear Output-Input Response

Nonlinearity is challenging for optical computing modules. (The nonlinearity here refers to the output-input relation but does not refer to the change of operating wavelengths such as harmonic generation.) Although some proposals and devices are made to conduct optical nonlinear computation^{3,4}, they are strongly limited by either high loss (saturable absorption) or narrow bandwidth (cavity-based response). Different from any existing design, where extra efforts and fabrication of another optical module conducting nonlinear parts are required, these imaginary-index-driven devices can support nonlinear response naturally from the carrier dynamics in semiconductor materials.

Due to the limited population of carriers⁵, saturable gain and saturable loss can be obtained, where the imaginary index depends on the local light intensity I(r). As a result, depending on the pumping level, the imaginary index can support three different regimes: saturable loss, transparency, and saturable gain. The corresponding input-output curves are convex, linear, and concave, which offers the potential to realize a neurophotonic network with nonlinear functions. Various embodiments can use a simple model to consider an imaginary index depending on local light intensity:

$${ε}_{i m a g} ( I , r ) = \frac{N - {N}_{T}}{1 + \frac{I ( r )}{{I}_{sat}}} , \qquad ( 20 )$$

where N and NT are the local carrier density and the transparency carrier density, I and Iₛₐₜ denote local light intensity and the saturation intensity. This imaginary index can give a nonlinear optical response to the signal while propagating:

$$dI = \frac{bI}{1 + \frac{I}{{I}_{sat}}} dr , \qquad ( 21 )$$

with a constant b depending on the pumping level. Various embodiments have experimentally confirmed the change of different nonlinear phases by tuning the pumping intensity (FIG. 14). The dots represent the measured data, and the curves are the fitting results to the theoretical models. Although the nonlinearity is limited with an undesigned uniform pumping, it is believed that the nonlinear response can be enhanced by better designing the pattern rather than a uniform pumping.
   8. Comparison with Other Platforms Regarding the Device Performance

Here, device performance can be compared with other state-of-the-art broadband on-chip broadband programmable optical computing modules in Table 1.

Regarding the device performance, the device exhibits the most compact footprint and a large bandwidth. Different from the phase change materials (PCM) systems, the device does not require high energy for the reconfiguration of the matrix, therefore more suitable for real-time applications. The maintaining energy consumption is comparable with the state-of-the-art MZIs. Unlike any other platform, since the weights in the present case are generated by optical gain and loss, it is fully flexible to work in a loss mode (just like other platforms) with lower energy consumption, zero-insertion loss mode, or even amplification mode with more energy. Here Table 1 estimates energy consumption with the pumping energy around the zero-insertion loss mode.

TABLE 1
Comparison table of different optical computational modules ^{a}

| | Footprint | | Energy | Loss |
|---|---|---|---|---|
| Platforms | (μm × μm) | Bandwidth | consumption (pJ) ^{b} | (dB)^{c} |
| PCM⁶ | 1400 × 1100 | 14 THz | 2.5 + 12.8 nJ | 13 |
| | | | (reconfiguration) | |
| MZI^{3, 7} | 1400 × 600 | 3 THz | 18 | 9 |
| This work | 300 × 240 | 14 THz | 20^{d} | Lossless |

^{a} All the values are converted into devices with same input/output numbers (4 × 4) for comparison.
^{b} The energy used for a whole operation in matrix-vector multiplication.
^{c}The loss refers to only the on-chip loss, which does not include the loss for coupling on/off the chip.
^{d}To make the comparison reasonable, the signal rate is assumed to be at the same magnitude (25 GHz used for the estimation of the device). The energy consumption is estimated by [average pumping power (0.5 mW)]/[potential operation speed (25 GHz) × pump filling ratio (100 kHz × 10 ns)] = 20 pJ

It can be noted that the footprint listed in Table 1 is only referred to as the on-chip footprint of the reconfigurable processors, which is not equivalent to the overall system compactness. It does not take into account an SLM and an alignment system needed for optical coding schemes. On the other hand, it is important to emphasize that, fundamentally distinguished from other platforms, the lithography-free paradigm intrinsically offers a node-free solution to construct an on-chip optical network. This node-free approach significantly simplifies the network design and thus reduces the area limit required for the device footprint on-chip. In the future, it is important to develop proper device packaging technologies to fully take advantage of this unique feature, such as miniaturized integration with on-chip amplitude-based spatial light modulation technologies⁸, or the eventual development of electrically injected coding schemes.

It is also important to note that energy consumption in the device in Table 1 is calculated based on the pumping power applied. Nevertheless, the actual power absorbed by InGaAsP is only 19% of the pumping power, corresponding to 3.8 pJ really required to (re)configure the photonic network. With further optical designs to increase the absorption of pumping light, the energy requirement for the device is expected to be dramatically reduced.

FIG. 15 depicts a computing device that can be used in various aspects, such as servers, computing, and/or devices; such a device can be in communication with a system according to the present disclosure, for example, a system according to any one of Aspects 10-17. A system according to the present disclosure—for example, a system according to any one of Aspects 10-17—can also be comprised in a computing device according to FIG. 15. The computer architecture shown in FIG. 15 shows a server computer, workstation, desktop computer, laptop, tablet, network appliance, PDA, e-reader, digital cellular phone, laboratory instrument, or other computing node, and can be utilized to execute any aspects of the computers described herein, such as to implement the methods herein.

The computing device 1500 can include a baseboard, or “motherboard,” which is a printed circuit board to which a multitude of components or devices can be connected by way of a system bus or other electrical communication paths. The computing device 1500 can comprise one or more processing units, such as a central processing unit, intelligence processing unit (IPU), graphics processing unit (GPU), and/or any other processor described herein. The one or more processing units 1504 can operate in conjunction with a chipset 1506. The PU(s) 1504 can be standard programmable processors that perform arithmetic and logical operations necessary for the operation of the computing device 1500.

The one or more processing units 1504 can perform the necessary operations by transitioning from one discrete physical state to the next through the manipulation of switching elements that differentiate between and change these states. Switching elements can generally include electronic circuits that maintain one of two binary states, such as flip-flops, and electronic circuits that provide an output state based on the logical combination of the states of one or more other switching elements, such as logic gates. These basic switching elements can be combined to create more complex logic circuits including registers, adders-subtractors, arithmetic logic units, floating-point units, and the like.

The PU(s) 1504 can be augmented with or replaced by other processing units, such as GPU(s), IPU(s), and/or the like. The GPU(s) and/or IPU(s) can comprise processing units specialized for but not necessarily limited to highly parallel computations, such as graphics and other visualization-related processing.

A chipset 1506 can provide an interface between the CPU(s) 1504 and the remainder of the components and devices on the baseboard. The chipset 1506 can provide an interface to a random access memory (RAM) 1508 used as the main memory in the computing device 1500. The chipset 1506 can further provide an interface to a computer-readable storage medium, such as a read-only memory (ROM) 1520 or non-volatile RAM (NVRAM) (not shown), for storing basic routines that can help to start up the computing device 1500 and to transfer information between the various components and devices. ROM 1520 or NVRAM can also store other software components necessary for the operation of the computing device 1500 in accordance with the aspects described herein.

The computing device 1500 can operate in a networked environment using logical connections to remote computing nodes and computer systems through local area network (LAN) 1516. The chipset 1506 can include functionality for providing network connectivity through a network interface controller (NIC) 1522, such as a gigabit Ethernet adapter. A NIC 1522 can be capable of connecting the computing device 1500 to other computing nodes over a network 1516. It should be appreciated that multiple NICs 1522 can be present in the computing device 1500, connecting the computing device to other types of networks and remote computer systems.

The computing device 1500 can be connected to a mass storage device 1528 that provides non-volatile storage for the computer. The mass storage device 1528 can store system programs, application programs, other program modules, and data, which have been described in greater detail herein. The mass storage device 1528 can be connected to the computing device 1500 through a storage controller 1524 connected to the chipset 1506. The mass storage device 1528 can consist of one or more physical storage units. A storage controller 1524 can interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 1500 can store data on a mass storage device 1528 by transforming the physical state of the physical storage units to reflect the information being stored. The specific transformation of a physical state can depend on various factors and on different implementations of this description. Examples of such factors can include, but are not limited to, the technology used to implement the physical storage units and whether the mass storage device 1528 is characterized as primary or secondary storage and the like.

For example, the computing device 1500 can store information to the mass storage device 1528 by issuing instructions through a storage controller 1524 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 1500 can further read information from the mass storage device 1528 by detecting the physical states or characteristics of one or more particular locations within the physical storage units.

In addition to the mass storage device 1528 described above, the computing device 1500 can have access to other computer-readable storage media to store and retrieve information, such as program modules, data structures, or other data. It should be appreciated by those skilled in the art that computer-readable storage media can be any available media that provides for the storage of non-transitory data and that can be accessed by the computing device 1500.

By way of example and not limitation, computer-readable storage media can include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that can be used to store the desired information in a non-transitory fashion.

A mass storage device, such as the mass storage device 1528 depicted in FIG. 15, can store an operating system utilized to control the operation of the computing device 1500. The operating system can comprise a version of the LINUX operating system. The operating system can comprise a version of the WINDOWS SERVER operating system from the MICROSOFT Corporation. According to further aspects, the operating system can comprise a version of the UNIX operating system. Various mobile phone operating systems, such as IOS and ANDROID, can also be utilized. It should be appreciated that other operating systems can also be utilized. The mass storage device 1528 can store other system or application programs and data utilized by the computing device 1500.

The mass storage device 1528 or other computer-readable storage media can also be encoded with computer-executable instructions, which, when loaded into the computing device 1500, transforms the computing device from a general-purpose computing system into a special-purpose computer capable of implementing the aspects described herein. These computer-executable instructions transform the computing device 1500 by specifying how the PU(s) 1504 transition between states, as described above. The computing device 1500 can have access to computer-readable storage media storing computer-executable instructions, which, when executed by the computing device 1500, can perform the methods described in herein.

A computing device, such as the computing device 1500 depicted in FIG. 15, can also include an input/output controller 1532 for receiving and processing input from a number of input devices, such as a keyboard, a mouse, a touchpad, a touch screen, an electronic stylus, or other type of input device. Similarly, an input/output controller 1532 can provide output to a display, such as a computer monitor, a flat-panel display, a digital projector, a printer, a plotter, or other type of output device. It will be appreciated that the computing device 1500 can not include all of the components shown in FIG. 15, can include other components that are not explicitly shown in FIG. 15, or can utilize an architecture completely different than that shown in FIG. 15.

As described herein, a computing device can be a physical computing device, such as the computing device 1500 of FIG. 15. A computing node can also include a virtual machine host process and one or more virtual machine instances. Computer-executable instructions can be executed by the physical hardware of a computing device indirectly through interpretation and/or execution of instructions stored and executed in the context of a virtual machine. The computing device 1500 can be configured to communicate via the network 1516 with other devices. For example, the computing device 1510 can process requests for a service, such as a search service (e.g., cognitive search service, artificial intelligence service, indexing service, natural language processing service, machine learning service, or a combination thereof).

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance can or can not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that can be used to perform the described methods and systems. When combinations, subsets, interactions, groups, etc., of these components are described, it is understood that while specific references to each of the various individual and collective combinations and permutations of these can not be explicitly described, each is specifically contemplated and described herein, for all methods and systems. This applies to all aspects of this application including, but not limited to, operations in described methods. Thus, if there are a variety of additional operations that can be performed it is understood that each of these additional operations can be performed with any specific embodiment or combination of embodiments of the described methods.

As will be appreciated by one skilled in the art, the methods and systems can take the form of an entirely hardware embodiment, an entirely software embodiment, or an embodiment combining software and hardware aspects. Furthermore, the methods and systems can take the form of a computer program product on a computer-readable storage medium having computer-readable program instructions (e.g., computer software) embodied in the storage medium. More particularly, the present methods and systems can take the form of web-implemented computer software. Any suitable computer-readable storage medium can be utilized including hard disks, CD-ROMs, optical storage devices, or magnetic storage devices.

Embodiments of the methods and systems are described herein with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions can be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions can also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions can also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above can be used independently of one another, or can be combined in various ways. All possible combinations and sub-combinations are intended to fall within the scope of this disclosure. In addition, certain methods or process blocks can be omitted in some implementations. The methods and processes described herein are also not limited to any particular sequence, and the blocks or states relating thereto can be performed in other sequences that are appropriate. For example, described blocks or states can be performed in an order other than that specifically described, or multiple blocks or states can be combined in a single block or state. The example blocks or states can be performed in serial, in parallel, or in some other manner. Blocks or states can be added to or removed from the described example embodiments. The example systems and components described herein can be configured differently than described. For example, elements can be added to, removed from, or rearranged compared to the described example embodiments.

It will also be appreciated that various items are illustrated as being stored in memory or on storage while being used, and that these items or portions thereof can be transferred between memory and other storage devices for purposes of memory management and data integrity. Alternatively, in other embodiments, some or all of the software modules and/or systems can execute in memory on another device and communicate with the illustrated computing systems via inter-computer communication. Furthermore, in some embodiments, some or all of the systems and/or modules can be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures can also be stored (e.g., as software instructions or structured data) on a computer-readable medium, such as a hard disk, a memory, a network, or a portable media article to be read by an appropriate device or via an appropriate connection. The systems, modules, and data structures can also be transmitted as generated data signals (e.g., as part of a carrier wave or other analog or digital propagated signal) on a variety of computer-readable transmission media, including wireless-based and wired/cable-based media, and can take a variety of forms (e.g., as part of a single or multiplexed analog signal, or as multiple discrete digital packets or frames). Such computer program products can also take other forms in other embodiments. Accordingly, the present invention can be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

It will be apparent to those skilled in the art that various modifications and variations can be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

### REFERENCES

1. Shastri, B. J. et al. Photonics for artificial intelligence and neuromorphic computing. Nat. Photonics 15, 102-114 (2021).
2. Feldmann, J. et al. Parallel convolutional processing using an integrated photonic tensor core. Nature 589, 52-58 (2021).
3. Cheben, P., Halir, R., Schmid, J. H., Atwater, H. A. & Smith, D. R. Subwavelength integrated photonics. Nature 560, 565-572 (2018).
4. Atabaki, A. H. et al. Integrating photonics with silicon nanoelectronics for the next generation of systems on a chip. Nature 556, 349-354 (2018).
5. Sludds, A. et al. Delocalized photonic deep learning on the internet's edge. Science 378, 270-276 (2022).
6. Piggott, A. Y. et al. Inverse design and demonstration of a compact and broadband on-chip wavelength demultiplexer. Nat. Photonics 9, 374-377 (2015).
7. Bogaerts, W. et al. Programmable photonic circuits. Nature 586, 207-216 (2020).
8. Hughes, T. W., Minkov, M., Shi, Y. & Fan, S. Training of photonic neural networks through in situ backpropagation and gradient measurement. Optica, OPTICA 5, 864-871 (2018).
9. Arrazola, J. M. et al. Quantum circuits with many photons on a programmable nanophotonic chip. Nature 591, 54-60 (2021).
10. Feldmann, J., Youngblood, N., Wright, C. D., Bhaskaran, H. & Pernice, W. H. P. All-optical spiking neurosynaptic networks with self-learning capabilities. Nature 569, 208-214 (2019).
11. Zhang, W. & Yao, J. Photonic integrated field-programmable disk array signal processor. Nat. Commun. 11, 406 (2020).
12. Liu, W. et al. A fully reconfigurable photonic integrated signal processor. Nat. Photon. 10, 190-195 (2016).
13. Zhao, H., Li, B., Li, H. & Li, M. Enabling scalable optical computing in synthetic frequency dimension using integrated cavity acousto-optics. Nat. Commun. 13, 5426 (2022).
14. Zhang, W., Mazzarello, R., Wuttig, M. & Ma, E. Designing crystallization in phase-change materials for universal memory and neuro-inspired computing. Nature Reviews Materials 4, 150-168 (2019).
15. Wu, C. et al. Programmable phase-change metasurfaces on waveguides for multimode photonic convolutional neural network. Nat. Commun. 12, 96 (2021).
16. Wuttig, M., Bhaskaran, H. & Taubner, T. Phase-change materials for non-volatile photonic applications. Nat. Photonics 11, 465-476 (2017).
17. Han, S. et al. Large-Scale Polarization-Insensitive Silicon Photonic MEMS Switches. J. Lightwave Technol. 36, 1824-1830 (2018).
18. Seok, T. J., Quack, N., Han, S., Muller, R. S. & Wu, M. C. Large-scale broadband digital silicon photonic switches with vertical adiabatic couplers. Optica, 3, 64-70 (2016).
19. Shen, Y. et al. Deep learning with coherent nanophotonic circuits. Nat. Photonics 11, 441-446 (2017).
20. Zhang, H. et al. An optical neural chip for implementing complex-valued neural network. Nat. Commun. 12, 457 (2021).
21. Ashtiani, F., Geers, A. J. & Aflatouni, F. An on-chip photonic deep neural network for image classification. Nature 606, 501-506 (2022).
22. Reck, M., Zeilinger, A., Bernstein, H. J. & Bertani, P. Experimental realization of any discrete unitary operator. Phys. Rev. Lett. 73, 58-61 (1994).
23. Nagarajan, R. et al. Large-scale photonic integrated circuits. IEEE J. Sel. Top. Quantum Electron. 11, 50-65 (2005).
24. Chrostowski, L. et al. Impact of fabrication non-uniformity on chip-scale silicon photonic integrated circuits. in Optical Fiber Communication Conference (OSA, 2014). doi:10.1364/ofc.2014.th2a.37.
25. Zhang, Z. et al. Tunable topological charge vortex microlaser. Science 368, 760-763 (2020).
26. Bahari, B. et al. Photonic quantum Hall effect and multiplexed light sources of large orbital angular momenta. Nat. Phys. 17, 700-703 (2021).
27. Mao, X.-R., Shao, Z.-K., Luan, H.-Y., Wang, S.-L. & Ma, R.-M. Magic-angle lasers in nanostructured moiré superlattice. Nat. Nanotechnol. 16, 1099-1105 (2021).
28. Zhao, H. et al. Non-Hermitian topological light steering. Science 365, 1163-1166 (2019).
29. Qiao, X. et al. Higher-dimensional supersymmetric microlaser arrays. Science 372, 403-408 (2021).
30. Molesky, S. et al. Inverse design in nanophotonics. Nat. Photonics 12, 659-670 (2018).
31. Piggott, A. Y., Petykiewicz, J., Su, L. & Vuckovid, J. Fabrication-constrained nanophotonic inverse design. Sci. Rep. 7, 1786 (2017).
32. Hughes, T. W., Minkov, M., Williamson, I. A. D. & Fan, S. Adjoint Method and Inverse Design for Nonlinear Nanophotonic Devices. ACS Photonics 5, 4781-4787 (2018).
33. Veronis, G., Dutton, R. W. & Fan, S. Method for sensitivity analysis of photonic crystal devices. Opt. Lett. 29, 2288-2290 (2004).
34. Rumpf, R. C. Simple implementation of arbitrarily shaped total-field/scattered-field regions in finite-difference frequency-domain. Prog. Electromagn. Res. B Pier B 36, 221-248 (2012).
35. Hillenbrand, J., Getty, L. A., Clark, M. J. & Wheeler, K. Acoustic characteristics of American English vowels. J. Acoust. Soc. Am. 97, 3099-3111 (1995).
36. Zhang, Z. et al. Ultrafast control of fractional orbital angular momentum of microlaser emissions. Light Sci Appl 9, 179 (2020).
37. Hall, K. L., Lenz, G., Darwish, A. M. & Ippen, E. P. Subpicosecond gain and index nonlinearities in InGaAsP diode lasers. Opt. Commun. 111, 589-612 (1994).
38. Moritz, P., Nishihara, R. & Jordan, M. A Linearly-Convergent Stochastic L-BFGS Algorithm. in Proceedings of the 19th International Conference on Artificial Intelligence and Statistics (eds. Gretton, A. & Robert, C. C.) vol. 51 249-258 (PMLR, 09-11 Can 2016).
39. Lenton, I. C. D., Stilgoe, A. B., Nieminen, T. A. & Rubinsztein-Dunlop, H. OTSLM toolbox for Structured Light Methods. Comput. Phys. Commun. 253, 107199 (2020).
40. Zhao, H. et al. Non-Hermitian topological light steering. Science 365, 1163-1166 (2019).
41. Qiao, X. et al. Higher-dimensional supersymmetric microlaser arrays. Science 372, 403-408 (2021).
42. Shen, Y. et al. Deep learning with coherent nanophotonic circuits. Nat. Photonics 11, 441-446 (2017).
43. Ashtiani, F., Geers, A. J. & Aflatouni, F. An on-chip photonic deep neural network for image classification. Nature 606, 501-506 (2022).
44. Dubovitsky, S., Steier, W. H., Mathur, A. & Dapkus, P. D. Gain saturation properties of a semiconductor gain medium with tensile and compressive strain quantum wells. IEEEJ. Quantum Electron. 30, 380-391 (1994).
45. Feldmann, J. et al. Parallel convolutional processing using an integrated photonic tensor core. Nature 589, 52-58 (2021).
46. Sludds, A. et al. Delocalized photonic deep learning on the internet's edge. Science 378, 270-276 (2022).
47. Smolyaninov, A., El Amili, A., Vallini, F., Pappert, S. & Fainman, Y. Programmable plasmonic phase modulation of free-space wavefronts at gigahertz rates. Nat. Photon. 13, 431-435 (2019).

### ASPECTS

The disclosure includes any of the following Aspects, which are illustrative only and do not serve to limit the scope of the present disclosure or the appended claims. Any part or parts of any one or more Aspects can be combined with any part or parts of any one or more other Aspects.

Aspect 1. A method for photonics processing, comprising: receiving at least one optical signal at a medium, wherein the medium comprises a lithography-free region, and wherein the medium optionally comprises a microchip; generating a first pumping pattern on the lithography-free region, the first pumping pattern defining a gain-loss distribution; spatially modulating the first pumping pattern based on an imaginary-index distribution to generate a second pumping pattern; and collecting an output from the medium.

Aspect 2. The method of Aspect 1, further comprising: monitoring the medium to detect the first pumping pattern; and determining the imaginary-index distribution based on the first pumping pattern and a target matrix.

Aspect 3. The method of any of Aspects 1 and 2, further comprising generating the imaginary-index distribution from a machine learning model trained to a target matrix.

Aspect 4. The method of Aspects 3, wherein the target matrix is an optimized power transmission matrix.

Aspect 5. The method of any of Aspects 1-4, further comprising applying a spatial light modulator (SLM) to spatially modulate the first pumping pattern.

Aspect 6. The method of any of Aspects 1-5, wherein spatially modulating the first pumping pattern occurs in real-time.

Aspect 7. The method of any of Aspects 1-6, further comprising converting audio signals to generate at least one optical signal.

Aspect 8. A method, comprising receiving at least one optical signal at a medium that comprises a lithography-free region, the medium optionally comprising a microchip; illuminating the lithography-free region so as to give rise to a pumping pattern therein that defines a gain-loss distribution on the lithography-free region, the pumping pattern being based at least in part on a target matrix; and collecting an output from the medium.

Aspect 9. The method of Aspect 8, wherein the at least one optical signal is encoded from an audio file or a video file.

Aspect 10. An integrated photonics system, comprising: a medium comprising a lithography-free region, wherein the medium exhibits, under illumination, a pumping pattern defining a gain-loss distribution on the lithography-free region; and a photonics processor configured to modulate the pumping pattern of the lithography-free region by spatially modulating the pumping pattern based on an imaginary-index distribution.

Aspect 11. The integrated photonics system of Aspect 10, further comprising a spatial light modulator (SLM), the SLM being in communication with the photonics processor, and the SLM configured to illuminate the lithography-free region so as to give rise to the pumping pattern of the lithography-free region.

Aspect 12. The integrated photonics system of any of Aspects 10-11, wherein the medium comprises an InGaAsP wafer.

Aspect 13. The integrated photonics system of any of Aspects 10-12, wherein the medium is configured to generate the pumping pattern based on received optical signals.

Aspect 14. The integrated photonics system of any of Aspects 10-13, wherein spatially modulating the pumping pattern occurs nonlinearly.

Aspect 15. The integrated photonics system of any of Aspects 10-14, wherein the imaginary-index distribution is generated from an in-situ trained target matrix.

Aspect 16. The integrated photonics system of any of Aspects 10-15, wherein the in-situ trained target matrix performs audio classification.

Aspect 17. The integrated photonics system of Aspect 16, wherein the audio classification is vowel recognition.

Aspect 18. A method, comprising operating the integrated photonics system according to any one of Aspects 10-17.

Aspect 19. The method of Aspect 18, wherein the operation comprises changing the pumping pattern.

Aspect 20. A method, comprising forming the integrated photonics system according to any one of Aspects 10-17.

What is claimed:

1. A method for photonics processing, comprising:
receiving at least one optical signal at a medium, wherein the medium comprises a lithography-free region, and wherein the medium optionally comprises a microchip;
generating a first pumping pattern on the lithography-free region, the first pumping pattern defining a gain-loss distribution;
spatially modulating the first pumping pattern based on an imaginary-index distribution to generate a second pumping pattern; and
collecting an output from the medium.

2. The method of claim 1, further comprising: monitoring the medium to detect the first pumping pattern; and determining the imaginary-index distribution based on the first pumping pattern and a target matrix.

3. The method of claim 1, further comprising generating the imaginary-index distribution from a machine learning model trained to a target matrix.

4. The method of claim 3, wherein the target matrix is an optimized power transmission matrix.

5. The method of claim 1, further comprising applying a spatial light modulator (SLM) to spatially modulate the first pumping pattern.

6. The method of claim 1, wherein spatially modulating the first pumping pattern occurs in real-time.

7. The method of claim 1, further comprising converting audio signals to generate at least one optical signal.

8. A method, comprising:
receiving at least one optical signal at a medium that comprises a lithography-free region, the medium optionally comprising a microchip;
illuminating the lithography-free region so as to give rise to a pumping pattern therein that defines a gain-loss distribution on the lithography-free region, the pumping pattern being based at least in part on a target matrix; and
collecting an output from the medium.

9. The method of claim 8, wherein the at least one optical signal is encoded from an audio file or a video file.

10. An integrated photonics system, comprising:
a medium comprising a lithography-free region, wherein the medium exhibits, under illumination, a pumping pattern defining a gain-loss distribution on the lithography-free region; and
a photonics processor configured to modulate the pumping pattern of the lithography-free region by spatially modulating the pumping pattern based on an imaginary-index distribution.

11. The integrated photonics system of claim 10, further comprising a spatial light modulator (SLM), the SLM being in communication with the photonics processor, and the SLM configured to illuminate the lithography-free region so as to give rise to the pumping pattern of the lithography-free region.

12. The integrated photonics system of claim 10, wherein the medium comprises an InGaAsP wafer.

13. The integrated photonics system of claim 10, wherein the medium is configured to generate the pumping pattern based on received optical signals.

14. The integrated photonics system claim 10, wherein spatially modulating the pumping pattern occurs nonlinearly.

15. The integrated photonics system claim 10, wherein the imaginary-index distribution is generated from an in-situ trained target matrix.

16. The integrated photonics system of claim 10, wherein the in-situ trained target matrix performs audio classification.

17. The integrated photonics system of claim 16, wherein the audio classification is vowel recognition.

18. A method, comprising operating the integrated photonics system according to claim 10.

19. The method of claim 18, wherein the operation comprises changing the pumping pattern.

20. A method, comprising forming the integrated photonics system according to claim 10.
